(19) United States
(12) Patent Application Publication
(10) Pub. No.: US 2010/0231700 A1
(43) Pub. Date: Sep. 16, 2010

(54) 3D SCREEN WITH MODULAR POLARIZED PIXELS

(75) Inventors: Bassam D. Jalbout, Quebec (CA); Brian Wong, Kirkland (CA)

Correspondence Address: McDermott Will & Emery, 600 13th Street, NW, Washington, DC, 20005-3096, US

(73) Assignee: LSI INDUSTRIES, INC., Cincinnati, OH (US)

(21) Appl. No.: 12/498,701

(22) Filed: Jul. 7, 2009

Related U.S. Application Data
(60) Provisional application No. 61/158,838, filed on Mar. 10, 2009.

(51) Int. Cl. H04N 15/00; G02F 1/1335; G09G 3/36

(52) U.S. Cl. 348/58; 349/15; 345/87

(57) ABSTRACT

Modular light source are described with polarized states and a video screen including a matrix of the modular light sources. Each modular light source may constitute a pixel of the screen. Each pixel may be controlled to emit light in a polarized state. As a result, the screen may generate images with different polarities at any pixel, at any time, in addition to generating non-polarized pixels or images if desired. Using a viewing device, such as glasses, having a lenses with different polarization characteristics, a viewer may perceive an image generated by the screen as having three dimensions. Related methods and computer program products are also described.

### RELATED APPLICATION

This application claims the benefit of U.S. Provisional Patent Application No. 61/158,838 filed 10 Mar. 2009, and entitled “3D Screen with Modular Polarized Pixels”, the entire contents of which are incorporated herein by reference.

### BACKGROUND

Generally, conventional video screens are constructed by providing at least one planar surface to emit or reflect light that can be seen as an image by a viewer. Three types of conventional video screens are light emitting diode (LED), plasma discharge, and liquid crystal display (LCD) screens. Typically, these video screens include two or more light sources grouped to form a pixel. In color applications, the light sources often combine red, blue, and green lights the light from which is mixed to provide color for each pixel. The pixels are grouped together to form a screen which can be capable of presenting text, graphics, images, and videos to a viewer. LEDs have been used to make both large and small screens that have found use in both indoor and outdoor applications.

Such approaches can be limited by size and are not easily used to produce three-dimensional (“3D”) effects for people observing the screens.

### SUMMARY

The present disclosure addresses the limitations noted previously, and is directed to techniques, including systems, methods, and apparatus that can be used for 3D effects for images on a display screen that includes a plurality of light emitting elements (or, pixels) and with selective polarization for each lighting element (or, pixel). The pixels can be used to manufacture a screen of any large size, whereas the panel method can be restricted to the maximum size of the polarizing panel, generally a few inches. Also, all pixels in the panel can be polarized in the same direction at once, i.e. the entire panel, for a given polarization state, produce an entire image. Embodiments of the present invention can generate images with either polarity on any pixel at any time, and has the capability of generating a non-polarized pixel or image if desired Thus, three-dimensional (“3D”) effects can be realized, e.g., perceived images that appear to have a depth dimension.

The entire produced image can be visible by either eye from any direction Additionally, embodiments of the present disclosure can, by utilizing image selection by polarization instead of color, allow color blind (or impaired) individuals to experience the visual 3D effect(s).

In one general aspect, a modular pixel emitter assembly to implement a pixel in a screen includes an input to receive a pixel intensity data and a polarization data, the polarization data indicating one of a first polarization state and a second polarization state; an emitter circuit board including the input; at least one light emitting diode (LED) connected to the emitter board to emit light for the pixel according to the pixel intensity data; and a polarization control assembly to polarize the emitted light to a first angle of orientation in response polarization data indicating the first polarization state and to polarize the emitted light to a second angle of orientation orthogonal to the first angle in response polarization data indicating the second polarizing state.

In another general aspect, a modular video screen including a matrix of pixels to present polarized images. The screen includes a plurality of modular light sources forming the matrix, each modular light source comprising: an input to receive a pixel intensity data corresponding to a pixel in the matrix and a polarization data, the polarization data indicating one of a first polarization state and a second polarization state; an emitter circuit board including the input; at least one light emitting diode (LED) connected to the emitter board to emit light for the pixel according to the pixel intensity data; and a polarization control assembly to polarize the emitted light to a first angle of orientation in response polarization data indicating the first polarization state and to polarize the emitted light to a second angle of orientation orthogonal to the first angle in response polarization data indicating the second polarizing state.

The polarization control assembly may include a first polarizing layer, second polarizing layer, and a liquid crystal display (LCD) layer.

The polarization control assembly includes a first area and a second area, the first area configured to be transparent in response to polarization data indicating the first polarization state and to be opaque in response to polarization data indicating the second polarization state, and the second area configured to be transparent in response to polarization data indicating the second polarization state and to be opaque in response to polarization data indicating the first polarization state.

The first polarizing layer may include a first area to allow light having the first angle of orientation to pass through the first area and a second area to allow light having the second angle of orientation to pass through the second area, and the second polarizing layer includes a first area to allow light having the second angle of orientation to pass through the first area and a second area to allow light having the first angle of orientation to pass through the second area where the first area of the first layer corresponds to the first area of the second layer and the second area of the first layer corresponds to the second area of the second layer. The LCD layer may include a first area corresponding to the first areas of the first and second layers and a second area corresponding to the second areas of the first and second layers where the first and second areas of LCD layer rotate light entering the LCD layer 90 degrees. A control voltage applied to the first area of the LCD layer inhibits light from passing through an area polarization control assembly corresponding to the first areas and a control voltage applied to the second area of the LCD layer inhibits light from passing through an area polarization control assembly corresponding to the second areas.

Each modular light source also may include a processing device connected to the emitter circuit board to process the intensity data and polarization data to control the at least one LED to output the desired intensity and to control the polarization control assembly to polarize the emitted light.

The first angle polarizes light may correspond to a left eye image and the second angle of polarizes light orthogonal to the first angle may correspond to a right eye image.

The control assembly may be placed in the first polarization state when the pixel intensity data corresponds to a left eye image and the control assembly may be placed in the second polarization state when the pixel intensity data corresponds to a right eye image. When the control assembly may be placed in a third polarization state the emitted light can be not polarized.

Each modular light source also may include a cover to diffuse the polarized light from the control assembly evenly over a desired angle of emission.

The LED may be a tri-color LED to emit colored light corresponding to the desired intensity. Each modular light source also may include a plurality of LEDs connected to the emitter circuit board to emit light according to a desired intensity for the pixel.

The intensity data supplied to the pixel emitter assemblies may include left eye image data and right eye image data, where the left eye data can be synchronized to the first angle, and where the right eye image data can be synchronized to the second angle.

The images presented by the screen may have a three dimensional quality when viewed by a viewing device having a first lens polarized to the first angle and a second lens polarized to the second angle.

Embodiments of the present disclosure can utilize TIME MULTIPLEXED pixels; the SAME pixel can be used for multiple (e.g., both) views, e.g., not necessarily subareas; the polarization can be cycled as desired (e.g., left and right). Such can provide the advantage of twice the resolution of subarea methods.

One skilled in the art will appreciate that embodiments and/or portions of embodiments of the present disclosure can be implemented in/with computer-readable storage media (e.g., hardware, software, firmware, or any combinations of such), and can be distributed over one or more networks. Steps described herein, including processing functions to derive, learn, or calculate formula and/or mathematical models utilized and/or produced by the embodiments of the present disclosure, can be processed by one or more suitable processors, e.g. central processing units (“CPUs) implementing suitable code/instructions in any suitable language (machine dependent on machine independent). Furthermore, software embodying methods, processes, and/or algorithms of the present disclosure can be implemented in or carried by electrical signals, e.g., for downloading off of the Internet. While aspects of the present disclosure are described herein in connection with certain embodiments, it should be noted that variations can be made by one with skill in the applicable arts within the spirit of the present disclosure.

Other features will be apparent from the description, the drawings, and the claims.

### BRIEF DESCRIPTION OF THE DRAWINGS

While certain embodiments/aspects of the present disclosure are described herein, other embodiments/aspects according to the present disclosure will become readily apparent to those skilled in the art from the following detailed description, wherein exemplary embodiments are shown and described by way of illustration. In the drawings:

FIG. 1 depicts a screen system, in accordance with an exemplary embodiment of the present disclosure;

FIG. 2A depicts alternate views of a modular pixel or light source with polarizable states, in accordance with an exemplary embodiment of the present disclosure;

FIG. 2B depicts an exploded view of a modular light source similar to the embodiment of FIG. 2A;

FIG. 3 show examples of the operation of an exemplary polarization control assembly, in accordance with an embodiment of the present disclosure;

FIG. 4 shows examples of various configurations for polarization area of the polarization control assembly, in accordance with an embodiment of the present disclosure;

FIG. 5 can be an exemplary interconnecting element which connects two modular pixels, or modular light source elements, together, in accordance with an embodiment of the present disclosure;

FIG. 6 shows an exemplary connection at the junction of the interconnecting element and the light source or pixel module, in accordance with an embodiment of the present disclosure;

FIG. 7 shows an exemplary portion of a screen structure, in accordance with an embodiment of the present disclosure;

FIG. 8 shows an exemplary front view of a screen system, in accordance with an embodiment of the present disclosure;

FIG. 9 shows an exemplary top view of a screen system, in accordance with an embodiment of the present disclosure;

FIG. 10 shows an examplary process for generation of a 3D or stereoscopic image, in accordance with an embodiment of the present disclosure;

FIG. 11 shows an exemplary method of transfering data between daisy chained modular pixels, in accordance with an embodiment of the present disclosure;

FIG. 12 shows an exemplary method of distributing the power to the modular pixels in a screen system, and an exemplary method to regulate the power source at each modular pixel, in accordance with an embodiment of the present disclosure;

FIG. 13 shows an exemplary screen system, in accordance with an embodiment of the present disclosure;

FIGS. 14 shows an exmplary DVI controller for the screen system, in accordance with an embodiment of the present disclosure;

FIG. 15 shows an example of the combination of the left view and right view video data and timing assoicated therewith, in accordance with an embodiment of the present disclosure;

FIG. 16 shows an example of a DVI control unit operating with left view and right view video data over time, in accordance with an embodiment of the present disclosure;

FIG. 17 shows an example cross polarized glasses that may be used to view a modular three dimensional screen, in accordance with an embodiment of the present disclosure; and

FIG. 18 shows another exemplary screen system, in accordance with an embodiment of the present disclosure;

The techniques and algorithms of the present disclosure can be capable of other and different embodiments, and details of such can be capable of modification in various other respects. Accordingly, the drawings and detailed description can be to be regarded as illustrative in nature and not as restrictive. While certain embodiments depicted in the drawings, one skilled in the art will appreciate that the embodiments depicted can be illustrative and that variations of those shown, as well as other embodiments described herein, may be envisioned and practiced within the scope of the present disclosure.

### DETAILED DESCRIPTION

The following describes a substantially modular structure comprising video screen consisting of a matrix of individual modular light sources with polarized states to display polarized images that may be perceived by a viewer as three dimensional (3D). In the overall structure, a matrix of individual modular light sources can be held in place by modular interconnecting elements to create a generally two dimensional planar structure. The interconnecting elements carry the power and the electrical signals used by the modular light source. Each modular light source may constitute a pixel of the screen having polarized states. As the structure can be fully modular to the individual modular light source or pixel, the overall construction may be customized to any desired size and resolution, as explained in further detail below. In addition, each pixel may be polarized. As a result, the screen may generate images with different polarities at any pixel, at any time, in addition to generating non-polarized pixels or images if desired. Using polarized glasses, a viewer may perceive an image generated by the screen as having three dimensions. Furthermore, the entire image can be visible by either eye of a view from any direction. The pixels for the left eye and right eye can be the same pixels.

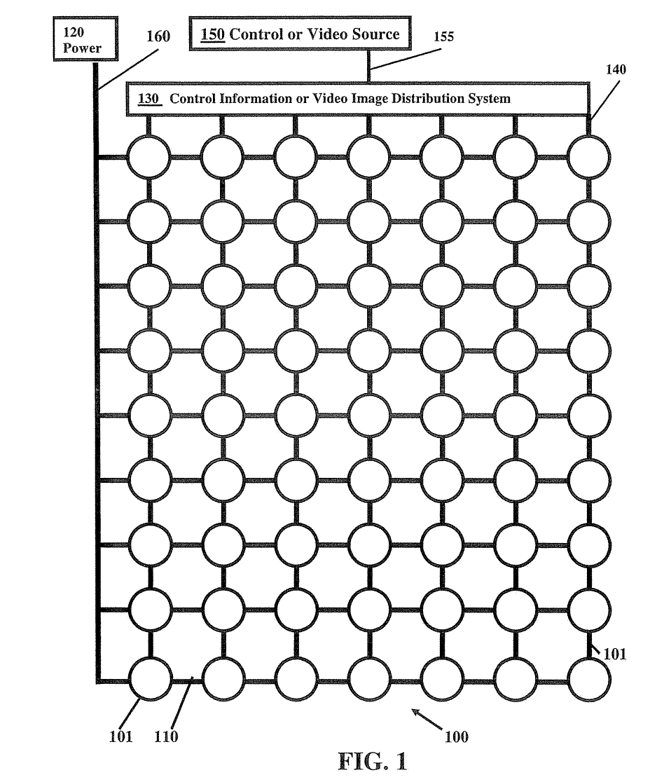

FIG. 1 shows one example of an overall structure 100 of a video screen according to an exemplary embodiment. The structure 100 includes a number of light sources 101, interconnecting elements 110, a power source 120, a controller information distribution system 130, a data link 140, a video or control information or control information source 150, a video signal or control information link 155, and a power link 160. The screen 100 can be modular in design. For example, each light source 101 and each interconnecting element 110 can be substantially the same. Four or more light sources 101 may be combined using the interconnecting elements to form a matrix of any desired size and resolution, as explained in connection with the examples given below.

The light sources 101 include an assembly of one or more lights positioned to emit light to a viewer Any type of light source may be used. In one embodiment, one or more LEDs can be provided by each light source 101 to emit light to a viewer. If two or more different colored lights can be used, their light may be mixed to emit different colors. For example, using a combination of red, green, and blue LEDs may produce more than 1.07 billion colors when their intensities can be controlled and their light can be mixed. The intensity of the lights may be controlled using a number of different modulation techniques, such as, for example, pulse width modulation, frequency modulation, amplitude modulation, or fixed frequency-fixed duration modulation. The light source can include contacts for data communication and power supply. Each light source 101 may be used to implement a pixel of a display screen, as described in further detail below.

Each light source or pixel 101 can be a modular unit that may be secured by framework including a number of interconnecting elements 110. The interconnecting elements 110 can be used to space the modular light sources 101 apart from each other and to provide support for the modular light sources 101 within in the overall structure 100. The interconnecting elements 110 can be formed of a size such that the interconnecting elements 110 provide the structural strength and integrity of the screen by securing the light elements, while minimizing the visibility of the connecting elements 110 to a viewer of the structure to the point that the interconnecting elements 110 can be generally not perceived by a viewer when viewing the structure as a whole.

The visibility of the interconnecting elements 110 may be further diminished by using a translucent and/or transparent material to construct the interconnecting elements 110. For example, when the supporting structure can be made of a translucent and/or transparent material, such as glass, Plexiglas, or a clear or semi clear plastic, the resultant structure can be perceived by a viewer as substantially, visually transparent. The interconnecting elements 110 also may be made of a dark color (e.g., black) or other color that minimizes the amount of reflected light from the video screen, which can be less noticeable to the eye. The interconnecting elements 110 also may space the modular lighting sources 101 sufficiently apart from each other such that a significant amount of empty space can be formed between the light sources 101 to give the viewer a perception of a structure that can be substantially see-through or transparent.

Although FIG. 1 shows the relative spacing between adjacent modular light sources 101 as equidistant, different interconnector lengths may be used. For example, the distance between columns of modular light sources 101 or rows of modular light sources 101 may be varied forming, for example, a rectangular matrix instead of a square matrix, and by using at least two different lengths of interconnecting elements 110 (e.g., a first length for interconnecting elements in a row and a second length for interconnecting elements in a column).

In the example shown in FIG. 1, each modular light source 101 may be connected by two, three, or four interconnecting elements 110. The interconnecting elements 110 position the modular light sources 101 within the structure in a generally planar, grid-like pattern; however, other non planar structures also may be implemented, as explained in further detail bellow.

Although each modular light source 101 in a screen can be identical and may be placed in any position in the screen, each modular light source 101 may be provided with a unique light color and intensity value for display. Thus, any video image or light pattern may be generated and provided to the screen for display or lighting effect. The data distribution scheme providing unique light color and intensity values to each modular light source 101 can be described in further detail below.

The power source 120 provides power to the modular light sources 101. Any power source may be used that can be compatible with the modular light source 101. It can be understood, the power source may be implemented using one or more units and may include any number of devices needed to rectify, convert, and/or supply power to the modular light sources 101 as required by a particular implementation. A single power source 120 can be used to power the entire screen provided that power supply supplies the necessary current. In the implementation of FIG. 1, a single 48 Volt DC power supply can be used to power the entire screen 100. As described below, individual power regulators may be provided by modular light sources 101 to regulate the voltage as needed by the particular circuitry of the modular light source used in any application (e.g., 5 volts logic on the electronics board of the light source).

The control/data distribution system 130 may be implemented using one or more control boards. Each control board may make use of a processing device, such as, for example, a processor, an ASIC, a digital signal processor, a microcomputer, a central processing unit, a programmable logic/gate array, or other digital logic device to generate, among other things, the control signals for controlling the light sources 101. The processing device can be capable of responding to and executing instructions in a defined manner. The processing device may run one or more software applications to command and direct the processing device, such as, for example, applications to generate control and/or data signals for controlling the light sources 101 to emit light in a desired manner, including, for example, controlling color, intensity and contrast of the light emitted and/or to present text, graphics, images, and video. The software applications may include a computer program, a piece of code, an instruction, or some combination thereof for independently or collectively instructing the processing device to operate as desired. The processing device also may access, store, and/or create data in response to the applications.

The applications and data may be embodied permanently or temporarily in any type of machine, component, physical or virtual equipment, storage medium, or propagated signal wave capable of providing instructions or data to or being interpreted by the processing device. In particular, the controller 130 may include one or more storage mediums or memories to store the applications or data may including volatile and non-volatile memories (e.g., a read only memory (ROM), a random access memory (RAM), a flash memory, a floppy disk, a hard disk, a compact disk, a tape, a DROM, a flip-flop, a register, an SRAM, DRAM, PROM, EPROM, OPTROM, EEPROM, NOVRAM, or RAMBUS, etc.), such that if the memory can be read by the processing device, the specified steps, processes, and/or instructions can be performed. The memory may include an interface, such that data and applications may be loaded and stored in the memory allowing the applications, programming, and data to be updated, changed, or augmented. The memory also may be removable, such as, for example, a card, a stick, or a disk that can be inserted in or removed from a device. As a result, the memory may accommodate different sets of, data and/or programs to allow the processing device to be adapted to different applications, uses, embodiments, situations and/or scenarios.

The control/data distribution system 130 also may include one or more interfaces. The interfaces may be provided to exchange data with the components of the system units or components using various communications paths 140. The interface may be implemented as part of the processing device or separately to allow the processing device to communicate with other devices. The interface may include two or more types of interfaces, including interfaces for different types of hardware and for different types of communications media and protocols to translate information into a format that may be used by the processing device. Similarly, the interface may translate data/information received from the processing device to a format that may be transmitted to other devices and units of the system, such as the light sources 101 via a communications path The interface allows the processing device to send and receive information using the communications paths. In particular, the controllers may have multiple outputs of the same interface signal, which allows that signal to be branched out to a multiple number of other controller units. Details for the distribution of control or video information to the pixels can be described in detail below.

The data for display by screen 100 may be provided to the control/data distribution system 130 from a control or data source 150 via the data communications link 155. The control or data source 150 provides the display control/data to the control data/distribution system 130. The control data includes the desired polarization state accompanying the video data. The control/data distribution system then provides the data for use by the individual modular light sources 101 in the form of first and second video data (erg., both a left and a right view), polarization, intensity, and/or color data used by the modular light sources to provide the desired illumination at a desired pixel within the screen 100.

Control/data signals may be provided to the structure using the communications paths 140. The communication paths 140 may be implemented using data cables. The communications paths 140 may be connected to a first row of modular light sources 101 of the screen 100. From the first row of modular light sources control/data signals can be then provided to each light source using a data distribution scheme, as explained in greater detail below. Control/data signals may be conveyed to each light source using a control signal path provided by the interconnecting elements 110 connected to the modular light sources, as described in further detail below.

The controller 130 supplies signals to each modular light source 101 or pixel of the screen 100 to control the intensity of the light and the polarization of the modular light source 101. The control/data distribution system 130 may control a combination of two or more colored lights for each light source 101 or pixel to create colored light (e.g., red, green, and blue light-emitting diodes may produce more than 1.07 billion colors, or to the human eye, the complete spectrum). The modular light source 101 may mix the light by controlling the intensity of each light of the light source 101 using a modulation technique, such as pulse width modulation, frequency modulation, amplitude modulation, and fixed frequency-fixed domain modulation using the data supplied by the control/data distribution system 130. Sets of data provided to each light source 101 may include intensity data including intensity data for the light source receiving the data set. By controlling each modular light source 101 or pixel, the entire screen 100 may be controlled to display text, graphics, images, and video or a combination thereof In addition, the data includes the control signals to control polarization states (e.g., polarization 1, polarization 2, and no polarization) provided to each light source to polarize light emitted from the light source 101. The polarization states 1 and 2 may be cross-polarized or orthogonal to each other. As a result, the screen 100 may be controlled to an individual pixel level to display text, graphics, images, illumination, and video or a combination thereof in one or more polarized states. In addition, the overall display (or portions thereof) may be perceived by a viewer wearing an appropriate viewing device or lenses as being three dimensional.

The overall structure 100 may be formed of modular components allowing different size structures to be formed. In the one example, the modular light sources 101 can be positioned generally in a plane to emit light on one side of the plane in a number of rows and columns. In the example of FIG. 1, a screen 7 pixels wide by 9 pixels high (63 pixels in total) can be shown; however, the overall screen may be formed of any number of rows and columns for the required pixel resolution and desired screen size. The light sources 101 can be positioned within the structure by the interconnecting elements 110. The interconnecting elements 110 secure the modular light sources 101 and provide both mechanical integrity and/or strength to the structure in addition to electrical connections for power and control of the modular light sources 101.

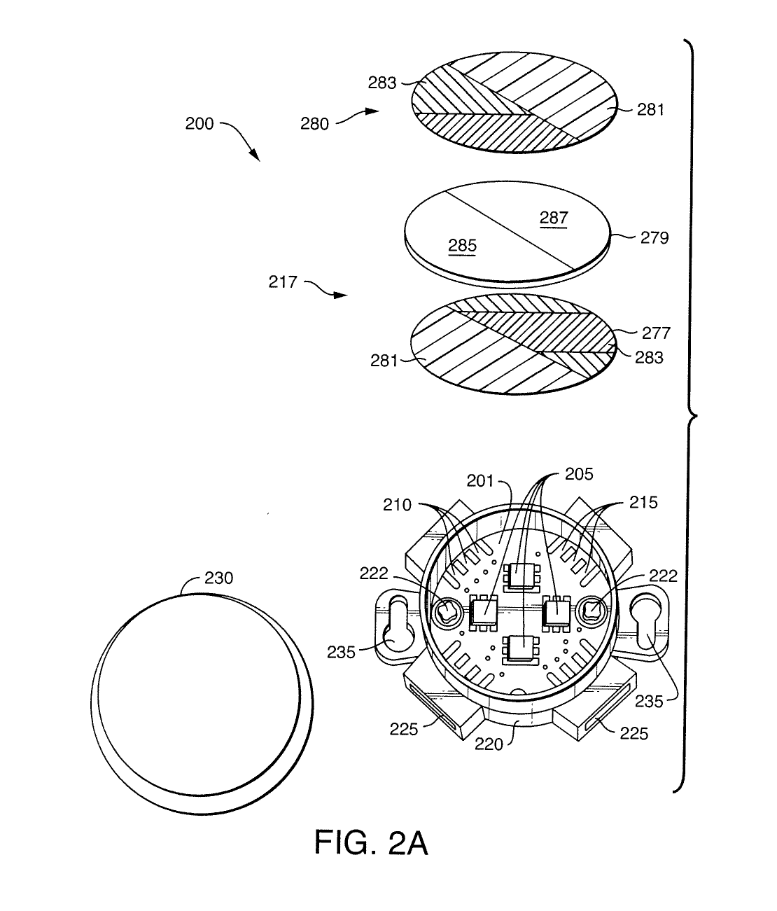

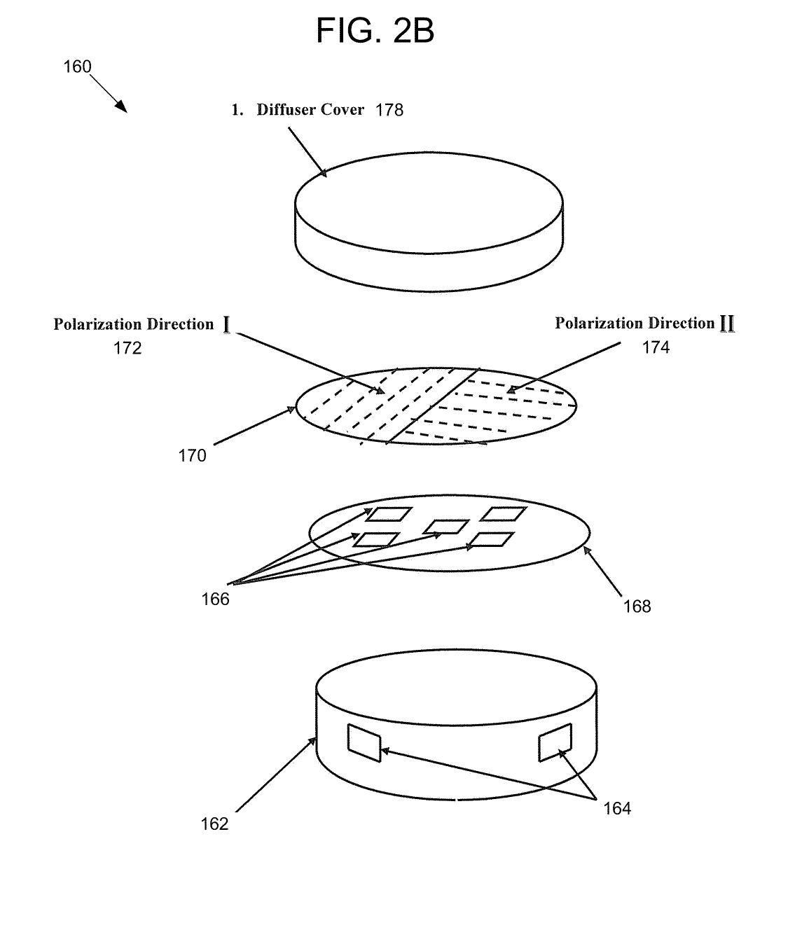

FIG. 2A depicts one example of a light source implemented as a pixel emitter assembly 200 having a plurality of polarization states. The pixel emitter assembly 200 can be a modular construct that emits visible polarized and nonpolarized light radiation As shown in FIG. 2 the polarized pixel emitter assembly 200 includes an emitter circuit board 201, LEDs 205, data contacts 210, power contact 215, a polarization control assembly 217, a housing 220, slots 225, a transparent cover 230.

The polarized pixel emitter assembly 200 includes an LED emitter circuit board 201 to mount, power, and control LEDs 205. In one implementation, four tricolored LEDs can be mounted on the emitter board 201 and can be electrically driven to a color and/or intensity according to the data and power provided to each polarized pixel emitter assembly 200 from the control/data distribution system 130 and power supply 120.

Each emitter board 201 has two sets of data contacts 210 and two sets of power contacts 215. The data contacts 210 couple with the interconnect elements 110 to allow data to be input to and output from each pixel emitter assembly 200. The data contacts 210 may be arranged opposite each other on LED emitter board 201 on a first axis in the housing.

The power contacts 215 also electrically couple with the interconnecting elements 110 to receiver power from the power supply 120. The power contacts 215 may be positioned opposite each other on LED emitter board 201 on a second axis that can be orthogonal to the first axis. As a result of this orientation, the pixel emitter assemblies may be interconnected so that data and polarization signals runs along the first axis and power runs along the second axis. In one example, the polarization signals can be provided using the data connections; however, they may be provided using with the power connections, as an alternative.

In addition to providing power, intensity, and color control to drive the LEDs 205 to the desired intensity and color, the emitter circuit board 201 also controls the state of the polarization control assembly 217 according to polarization control command data provided from the control/data distribution system 130. Although this polarization control data can be transmitted over separate electronic lines via the interconnection elements 110 in this example, in another configuration the polarization control data may be transmitted as part of the intensity/color data set or in addition to this data set.

The polarization control assembly 217 includes a first polarizing layer 277, a liquid crystal display (LCD) layer 279, and a second polarizing layer 280. The layers 277, 279, and 280 can be provided in planes substantially parallel to each other. The first and second polarizing layer layers 277 and 280 each include at least two polarizing areas to polarize light passing through the layers. Half of the polarizing layers 277 and 280 include a first polarizing area 281 such that light passing through the area 281 has a first angle of orientation or polarization. The other half of the polarizing layers 277 and 280 include a second polarizing area 283 such that light passing through the area 283 has a second angle of orientation or polarization. The first angle and the second angle of light emitted from the areas can be orthogonal to each other. The first and second polarizing areas 281 and 283 can be specifically positioned within the layers such that the first polarizing area 281 of the first polarizing layer 277 substantially corresponds to the second polarizing area 283 in the second layer 280. Likewise, the second polarizing area 283 of the first polarizing layer 277 can be oriented to substantially correspond to the first polarizing area 281 of the second polarizing layer 283. In other words, light passing through the first polarizing area 281 of the first polarizing layer 277 may pass through the second polarizing area 283 in the second layer 280, and light passing through the second polarizing area 283 of the first polarizing layer 277 may pass the first polarizing area 281 of the second polarizing layer 280.

The LCD layer 279 can be sandwiched between the first and second layers 277 and 280. The LCD layer 279 also can be divided into two areas 285 and 287 corresponding to areas of the first and second polarizing area 281 and 283 of the first polarizing layer 277 and of the second and first polarizing areas 283 and 281 of the second polarizing layer 280. Although the elements 277, 279, and 280 can be each shown as a single disk in FIG. 2, one will appreciate the elements may be formed of two or more separate parts for easier manufacturing.

When a control voltage from the emitter board 201 can be applied to the first area 285, light emitted by the LEDs 205 can be blocked by a corresponding half of the polarization control assembly 217. When the control voltage can be removed, light emitted by the LEDs can be polarized to the second angle of orientation by a corresponding half of the polarization control assembly 217. Likewise, when a control voltage from the emitter board 201 can be applied to and removed from the second area 287, the corresponding half of the polarization control assembly 217 blocks and emits light of having the first angle of orientation.

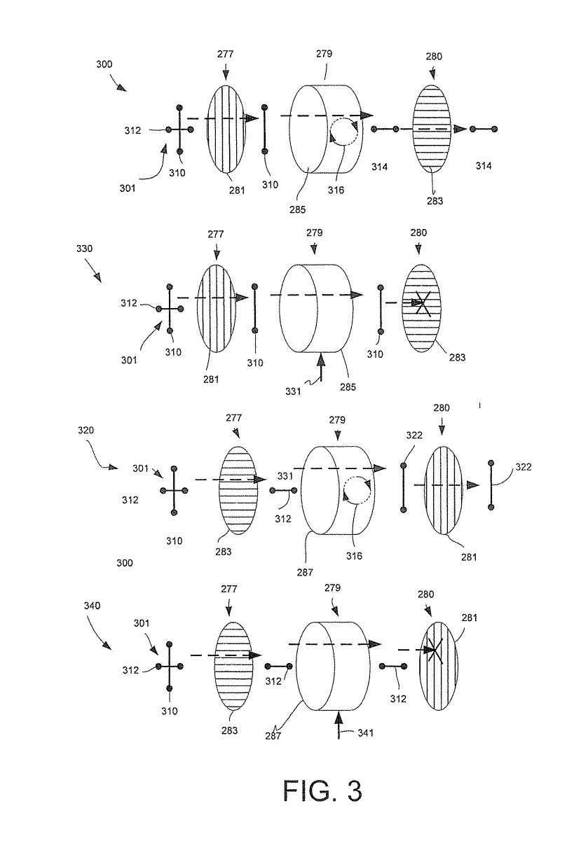

If a control voltage can be applied to LCD area 285 and not 287, polarized light having the first angle of orientation can be emitted from the pixel emitter assembly 200 (e.g., a first polarization state). If a control voltage is applied to LCD area 287 and not 285, polarized light having the second angle of orientation can be emitted from the pixel emitter assembly 200 (e.g., a second polarization state). If a control voltage is applied to both halves 285 and 287, the polarization control assembly 217 blocks light emitted by the LEDs 205 (e.g., a third polarization state), and/or if both control voltages are removed, the polarization control assembly 217 emits non-polarized light (e.g., a fourth polarization state). In one example, the LCD areas 285 and 287 may be implemented using commercially available liquid crystal display Operation of the polarization control assembly 217 can be described in further detail below with regard to FIG. 3.

The emitter board 201 also includes a storage device (not shown) to store the intensity and the polarization data. The emitter board 201 also includes a processing device (not shown) to control the intensity of the light emitted by the LEDs 205 and to control the polarization control assembly 217 to polarize light according to one of the states indicated by the polarization data (e.g., by controlling the voltage applied to the first and second areas).

The emitter board 201 also includes a voltage regulator (not shown) which drops the supply voltage (e.g., 48 volts DC) to a regulated voltage (ergo, 5 volts DC) used to power components of the emitter board 201.

The emitter board 201 can be seated in the housing 220. The housing 220 may include four connector slots 225 to connect to up to four interconnecting elements 110. The connector slots 225 allow access to the contacts 210 and 215 of the emitter board 201. In addition, the connector slots 225 help secure the interconnecting elements 110 in place. The housing 220 also may include several mounting features, such as tabs 235 for mounting pins or screws to allow the assembly to be secured to an additional frame or structure for added physical integrity of the entire structure, as described above.

The pixel emitter assembly 200 also may include a transparent cover 230 to protect the electronics while allowing emitted light to pass through The transparent cover 230 may snap fit or be screwed onto to the housing 220 allowing removal and/or replacement. The cover 230 may be formed with optical and/or diffusion qualities that diffuse light emitted from the LEDs of the emitter board 201 to make the light emission more evenly distributed over a desired angle of emission. Since the transparent cover 230 can be illuminated by any of the three polarization states, the same pixel (or light element/source) can be used for both left and right views, without resorting to sub-area divisions. Thus, embodiments of the present disclosure can provide greater resolution (e.g., twice as much) than systems/techniques utilizing sub-area polarization.

FIG. 2B depicts an exploded view of an embodiment 160 similar to that of FIG. 2A. As depicted in FIG. 2B, a modular pixel with polarized states can be used as a modular part of a larger video display screen or lighting system in exemplary embodiments. As seen in FIG. 2B, it can be enclosed in a pixel housing 162 with four pixel connector ports 164. These ports 164 can be used to physically hold and position the pixel in the screen array, as well as providing other functionality, ergs video signal information, power control, and/or polarization control. The light emitted from the LEDs 166 (which can be tri color) can be controlled by the video data obtained through the connections at the connector port 164. The video signal can be processed by circuit board 168 (which can be or include functionality of a video driver/card), which drives the LEDs 166 to the desired intensity and color, and which can also controls the state of the polarization control assembly 170. Each pixel in a video array can have its own specific intensity and color for any particular refresh of the video image. This emitted light passes through a polarization control assembly 170, which can be in any of three possible states, as determined by the polarization control command data, which can be also obtained through the cables on the connector ports 164. In exemplary embodiments, the three possible states can be polarization state I, polarization state II, or no polarization.

The polarization states I and II can be different from each other. In exemplary embodiments, the polarization states I and II can be orthogonal (90 degrees), or substantially so, and therefore can be mutually exclusive when viewed through a polarized lens. These two polarized states can be achieved by activating the specific area of the polarization control assembly, e.g., area 172 or area 174, such that the light through the undesired polarization direction can be blocked by a polarized LCD layer, which acts to cross-polarize (block) the undesired direction. This leaves only the desired polarization state to emit light.

The third state, which can be non-polarized, can be obtained by the non activation of either polarization control directions, thus allowing light to pass through both parts of the polarization control assembly 170 and results in non polarized light. The resulting emitted light, in any of the three desired states, passes through a diffuser cover 170, which spreads the light evenly throughout the desired viewing angle

With continued reference to FIG. 2B, the polarization control assembly 170 can include a sandwich (or layered stack) of materials, e.g. LCD layers. When an LCD layer can be subjected to a voltage, it produces a polarized barrier which allows the passage of only light with a specific polarization angle. By sandwiching this LCD layer with a polarization material which can be cross polarized, the two layers become opaque when the LCD can be activated, and pass light when the LCD can be deactivated. By having two such areas in the polarization control assembly 170, the passage of light can be blocked in either polarity, or not blocked. When a section can be blocked, the other remaining section emits the desired polarity, and vice versa. The two sections can be divided in any appropriate pattern, such as shown but not limited to those in FIG. 2B, where the vertical polarized areas of the polarization control assembly 170 can be shown in contrast to the horizontal polarized parts. As shown, a diffuser 178 can be present to produce an even illumination (or illumination evening/averaging) for the pixel no matter which polarity can be used. When neither polarity is blocked by not activating either LCD area, the resulting light can be non polarized. Note that although the polarization control assembly 170 shown has two areas of light transmission, the actual LED light can be emitted from the same LEDs for any of the states, and the resulting diffused light can be uniform and the same location for any of the states, e.g., the same pixel.

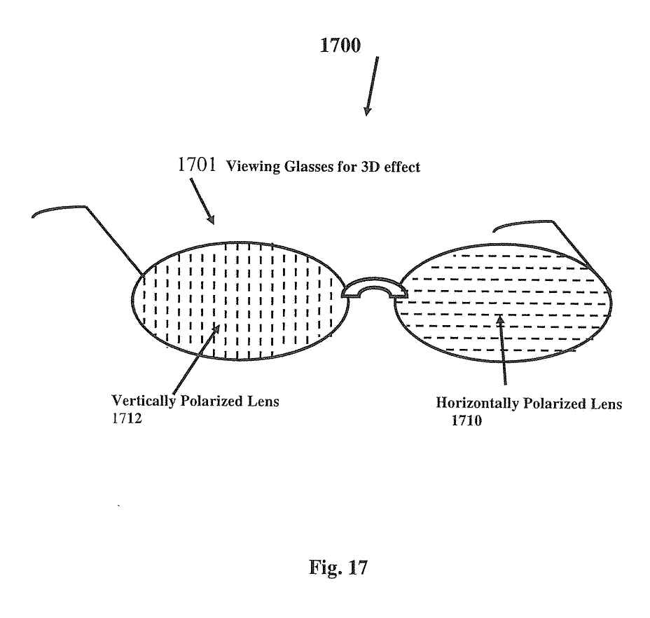

When a large video screen can be constructed of these modular pixels with polarized states, the result can be a screen, which can display a video image with a set polarization angle. By alternating left and right eye images while synchronizing the polarization angles, the result can be the presentation of a left eye image of one polarization direction, and the presentation of the right eye image with the cross polarization angle relative to the left eye image. Both these images can be viewable from any angle. Both these images can be emitted from the same pixel modules, thus the left and right images can be exactly in the same place, although they represent different viewpoints. There can be no subdivision of the image to produce the cross polarized images, the image can be thus twice the definition of any method using sub areas to polarize the images. The images can be seen in 3 dimensions or 3D, when correct viewing glasses 300 can be worn by the viewer, e.g., as depicted in FIG. 17. The left eye image can be isolated to the left eye by the correct polarization of the left eye lens, and the right eye image isolated to the right eye lens 320, since it can be cross polarized relative to the left.

FIG. 3 shows one example of the operation the polarization control assembly 217 in further detail. In general, light polarizing materials allow only one axis of a light wave to pass through the material, resulting in a “polarized” light, where the light wave vibration can be in a plane of a single angle rather than spread over the entire 360 degrees. When the polarized light impacts a second layer of the same polarizing material that can be at a 90 degrees alignment to the first (e.g., orthogonal to the first) nearly all the light can be blocked, since the second sheet allowing only light vibrations at 90 degrees can be presented with light vibration of exclusively 0 degrees after passing through the first layer. When the second layer can be at any other angle with respect to the first layer, the light intensity varies according to the Cosine of the angle. In other words, at 0 degrees, the Cosine 0=1 and 100% of the light can be passed (e.g., transparent), and at the Cosine 90=0 and 0% of the light can be passed (e.g , opaque). Thus in general, the intensity I=Cosine (Angle of second sheet with respect the first sheet).

Some molecules rotate polarized light by some angle because of their asymmetry. The asymmetry of the molecule causes it to rotate in one particular direction when struck by light energy. This rotation of the molecule causes the polarized light to deflect off at a slightly rotated angle. For any given molecule with this rotational property, the more concentrated the solution, or the further the light travels through it, the greater the angle of rotation of the polarized light. Some molecules rotate the polarized light in a right (clockwise) direction, while the same molecular formula when constructed in a mirror image configuration to the first, rotates the polarized light to the left (counter clockwise). Such molecules, although having the same chemical formula, can be designated —R or -L, according to its property for rotation of polarized light. Given that such materials used may be made in any desired thickness and any desired concentration, a material can be made that rotate polarized light 90 degrees, (i.e. twist the polarized light 90 degrees) when passing through the material. Some rotational materials, when subjected to an electrical voltage temporarily lose the ability to rotate polarized light. Thus, when a sheet of such a material was subjected to a varying voltage signal, the material rotates the polarized light when the voltage signal can be in the OFF state and does not rotate the polarized light when the voltage signal can be in the ON state. LCDs can be a practical application of these effects.

As shown in FIG. 3, various configurations show the design principles of the polarization control assembly 217. It should be noted that the following examples use the terminology vertical and horizontal vectors and polarization for illustration and descriptive purposes only, and any angles or polarizations that can be orthogonal to each other may be used to implement vertical and horizontal polarization scheme of the polarization control assembly 217 described below.

As shown in example 300, light 301 (emitted by the LEDs 205) includes both a horizontal vector 310 and vertical vector 312 (in addition to other vectors not shown for simplicity). As the light 301 passes through the first polarizing area 281 of layer 277, the light 301 becomes vertically polarized since only the vertical vector 310 passes through the polarizing area 281 (which has been set to a vertical orientation). The light intensity can be approximately 50% the original intensity, as one of the two light vibration vectors has been eliminated. The polarized light enters the LCD of area 285 of layer 279 which rotates the polarized light from a vertical vector 310 to a horizontal vector 314. The depth and density of the rotating material of the LCD can be selected to provide a total rotation 316 or twist of 90 degrees. The direction of rotation can be indicated by the arrows on 316, however, rotation of 90 degrees right gives the same final orientation as 90 degrees left (e.g., either right or left rotation provides horizontally polarized light). The polarizing area 283 of the second layer 280 can be set at a horizontal orientation, so the horizontal light 314 passes through the area 283 without change emerging as horizontally polarized light 314. In summation, non polarized light 301 has become horizontally polarized light 314 after passing though the set of layers 277, 279, and 280.

As shown in example 320, light 301 (emitted by the LEDs 205) includes both a horizontal vector 310 and vertical vector 312 (in addition to other vectors not shown for simplicity). As the light 301 passes through the second polarizing area 283 of layer 277, the light 301 becomes horizontally polarized since only the horizontal vector 312 passes through the polarizing area 283 (which has been set to a horizontal orientation). The light intensity can be approximately 50% the original intensity, as one of the two light vibration vectors has been eliminated. The polarized light 312 enters the LCD of area 287 of layer 279 which rotates the polarized light from a horizontal vector 312 to a vertical vector 322. The depth and density of the rotating material of the LCD can be selected to provide a total rotation 316 or twist of 90 degrees. The direction of rotation can be indicated by the arrows on 316, however, rotation of 90 degrees right gives the same final orientation as 90 degrees left (e.g., either right or left rotation provides horizontally polarized light). The polarizing area 281 of the second layer 280 can be set at a vertical orientation, so the vertical light 322 passes through the area 281 without change emerging as vertically polarized light 322. In summation, non polarized light 301 has become vertically polarized light 322 after passing though the set of layers 277, 279, and 280.

Example 330 shows the effect of a control voltage 331 applied to area 285 of the LCD layer 279. In this example, as the light 301 passes through the first polarizing area 281 of layer 277, the light 301 becomes vertically polarized since only the vertical vector 310 passes through the polarizing area 281. However, when a control voltage 331 from the emitter board 201 can be applied to area 285 the rotational effect 316 of the area 285 can be inhibited and vertical vector 310 passes through the area 285 without rotating. As the vertically polarized light 310 impacts area 283 which can be set at a horizontal orientation, the vertically polarized light 310 can be blocked. As a result, substantially no light emerges from the set of layers set of layers 277, 279, and 280, which can be effectively opaque.

Example 340 shows the effect of a control voltage applied to area 287 of the LCD layer 279. In this example, as the light 301 passes through the second polarizing area 283 of layer 277, the light 301 becomes horizontally polarized since only the horizontal vector 312 passes through the polarizing area 283. However, when a control voltage 341 from the emitter board 201 can be applied to area 287 the rotational effect 316 of the area 287 can be inhibited and horizontal vector 312 passes through the area 287 without rotating. As the horizontally polarized light 312 impacts area 281 which can be set at a vertical orientation, the horizontally polarized light 312 can be blocked. As a result, substantially no light emerges from the set of layers set of layers 277, 279, and 280, which can be effectively opaque.

Thus using a combination of LCD areas 285 and 287 in a pattern in front of LEDs 205 and applying control voltages thereto based on the polarization control signals, the emerging light can be controlled to be horizontally polarized (voltage applied to 285 only), vertically polarized (voltage applied to 287 only), non polarized (no voltage applied to either 285 or 287 resulting in both vectors 310 and 312 being present), or no light at all (voltage applied to both 285 and 287).

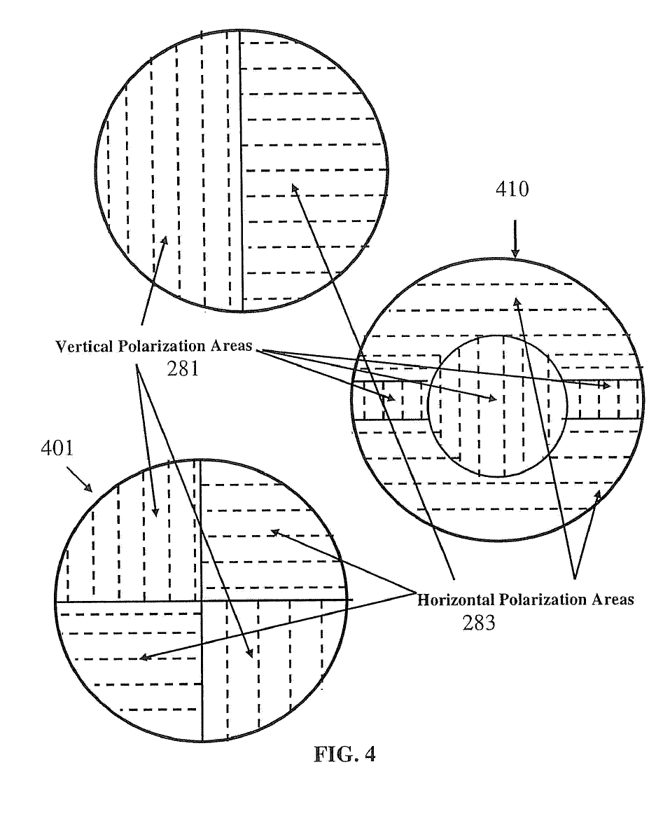

Although the polarization assembly 217 can be shown in FIG. 2A as being divided into two symmetrical or mirror image halves, other configurations can be possible as shown in FIG. 4. In one example 401, polarizing materials and LCD areas may be divided into four quadrants. Quadrants I and III may emit and block light of a first polarization. Quadrants II and IV may emit and block light of a second polarization Other complex configurations 410 can be possible, in which substantially half of the area can be polarized and blocked for one polarized state, and a corresponding other half of the area cross polarized and blocked, even though the halves can be not symmetric or mirror image.

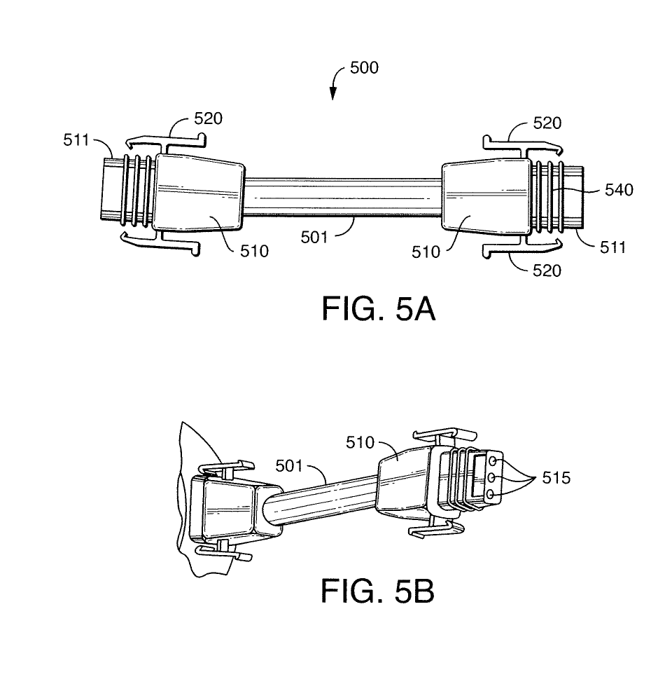

FIG. 5 shows one example of an interconnecting element 110 implemented as a strut 500. The strut 500 includes a body portion 501 that can be generally cylindrical along a first axis. The body portion 501 includes a relatively stiff outer housing that provides resistance across its axis (e.g., allowing some flexion or bending of the body) and can be very strong along its axis (e.g., the body resists shortening and lengthening). The housing of the body 501 encapsulates a number of data/power lines that provide data signals and power to the pixel emitter assemblies 200.

Each end of the strut body 501 includes a connector 510 that mates with any connector slot 225 of the pixel emitter assembly 200. The strut connector 510 includes a portion 511 that may be inserted into the slot 225 of the pixel emitter assembly connector. Each strut connector 510 includes a number of pins 515 to provide connections for the data and/or power lines. As the connector 510 can be inserted into the slot 225, the pins in the connector 510 electrically couple with either the data contact 210 or power contact 215 that corresponds to the slot 225. The pins 515 of the connector 510 electrically couple with the corresponding data contact 210 to receive or output display data or power contact 215 of the emitter board 201 to provide or receive power. As a result, the strut 500 may be used to connect the pixel emitter assembly 200 along either a power axis or a data axis (e.g., a row and column), and a single type of strut 500 may used to construct the entire screen. Thus, the modularity of the pixels can be fully realized as any number of pixel emitter assemblies 200 or any configuration of screen 100 can be constructed from the basic elements of the pixel emitter assemblies 200 and struts 500.

The connector 510 also includes a pair of fasteners 520 to secure the strut 500 to the pixel emitter assembly 200. The mechanical stiffness of the body 501 can be reinforced by the positive locking mechanism of the fasteners 520. In one implementation, the fastener may be a clip or a claw.

The dimensions of the strut body length may be varied during manufacturing to provide various spacing options between the pixel emitter assemblies 200. For smaller screens, (e.g., tip to approximately 20 modular pixels in height for struts having lengths of 3.5 to 4 inches, for exemplary embodiments), the struts 500 alone provide sufficient mechanical strength and integrity to for the screen 100 For larger applications, the pixel emitter assembly units 200 may be hard mounted onto a support, backing, and/or frame that can be transparent or translucent to provide sufficient mechanical support to maintain the physical integrity of the screen while the resultant screen can be still see-through.

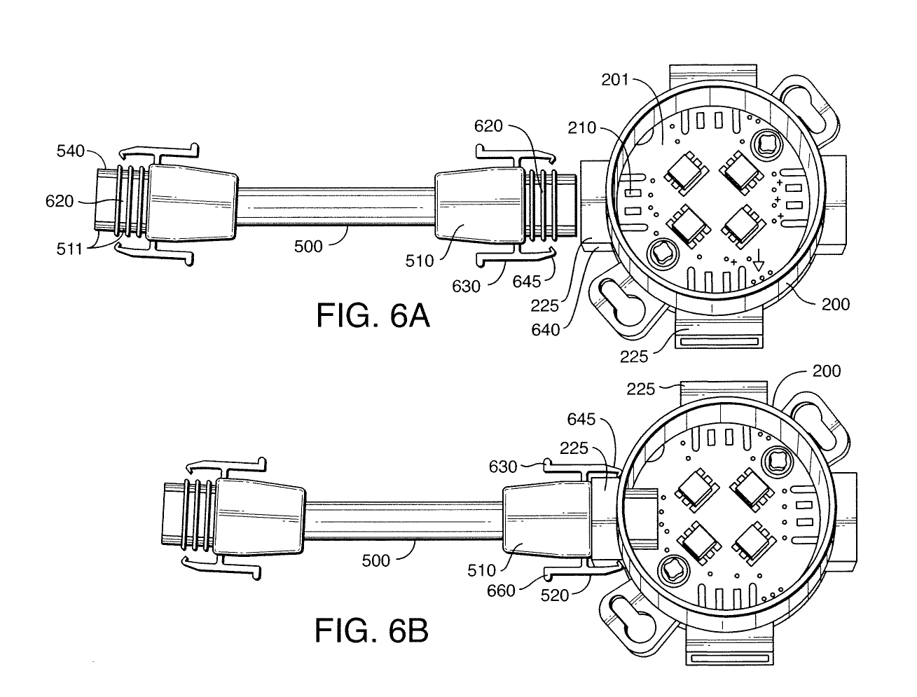

FIG. 6 shows mating of the slot 225 of the pixel emitter assembly 200 with connector 510 of the strut 500 of FIGS. 2 and 3. Each strut connector 510 includes a protruding portion 511 encapsulating a number of pins which can be inserted to the pixel emitter assembly slot 225. The pins electrically couple with the contacts of the emitter board 201 to carry the power and electronic data signals. The portion 511 may include ridges or guides 640 to ensure proper orientation of the connector 510 and alignment when inserted into the pixel emitter assembly connector 225. The strut connectors 510 also may include spacers 620, such as rings, to provide a better friction fit. The spacers 620 may be slightly flexible to allow for easy insertion into or removal from the slot 225 while providing a snug fit.

The strut connector fastener 520 may include two positive locking claws 630 to provide the mechanical rigidity required to construct a screen. As the strut connector 410 can be inserted into the pixel emitter assembly connector 225, the claws 630 travel along opposite sides of the pixel emitter assembly connector as the protruding portion 511 enters the slot 225 As the claws 630 travel along the side, they encounter a protrusion or ridge 640 of the pixel emitter assembly connector. As the strut connector 510 can be inserted, the claws bend or deform relative to a fulcrum 650 while passing over the ridge 640 to allow the strut connector 510 to continue to be inserted. Once the strut connector 510 can be inserted far enough to make electrical contact between the pins and the contacts, the claws 630 pass over the ridge 640 allowing the claws 630 to reconfigure or snap back to their original orientation. Once the claws 630 reconfigure to their original orientation, a hook 645 of the claw 630 locks against the ridge 640 to resist removal of the strut connector 510 from the slot 225.

A tail portion 660 of the fastener facilitates deformation of the claw about the fulcrum 650 causing the corresponding hook portion 645 to unlock from the ridge 640 and allow removal of the strut connector 510 from the pixel emitter assembly connector The connector arrangement allows easy assembly and disassembly of the screen as well as replacement of any parts.

Of course, other types of fasteners may be used. For example, screws or pins may be used to secure a strut connector to the pixel emitter assembly connector. Other types of snap fasteners also may be used. In addition, the strut connector 510 may be molded as a screw or bayonet, which can be inserted into the slot by twisting, screwing, or stabbing the connector 510 into place.

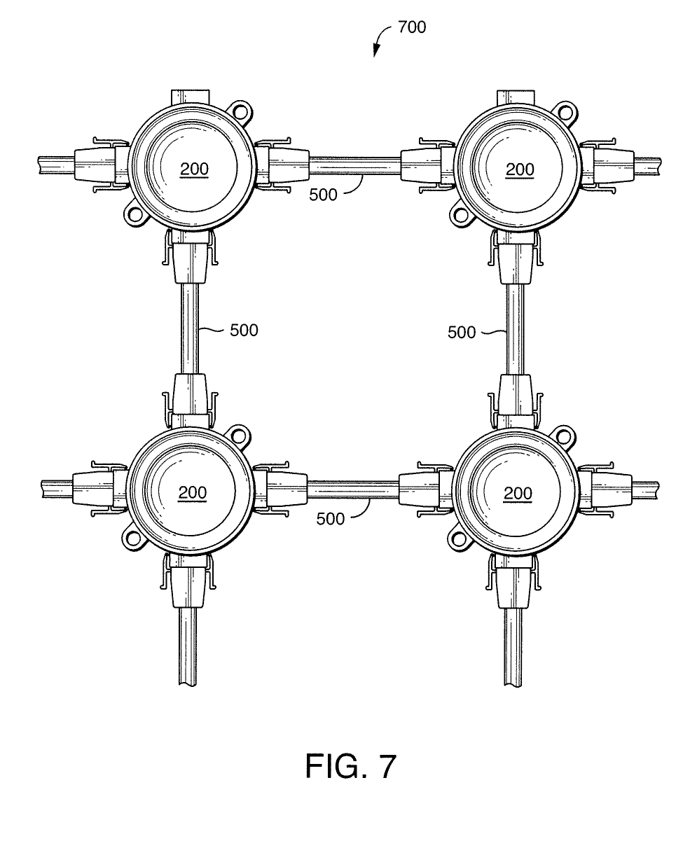

FIG. 7 shows an example of a portion of a screen structure, consisting of a matrix 700 of individual light source pixel emitter assemblies 200 that may be used to form pixels of a video screen. Each pixel emitter assembly 200 can be secured in its place within the screen by interconnecting elements 110, such as the struts 500. The struts 500 secure the pixel emitters 200 in a column and row formation relative to each other generally in a plane. In the example shown in FIG. 7, a 2×2 portion of a matrix can be shown. The 2×2 matrix may be expanded by as many additional pixel modules as necessary to create a screen of a desired size and resolution. By varying the numerical size of the matrix, any resolution or size of video display can be achieved. By varying the length of the struts 400, any desired screen pitch (e.g., pixels spacing) can be achieved.

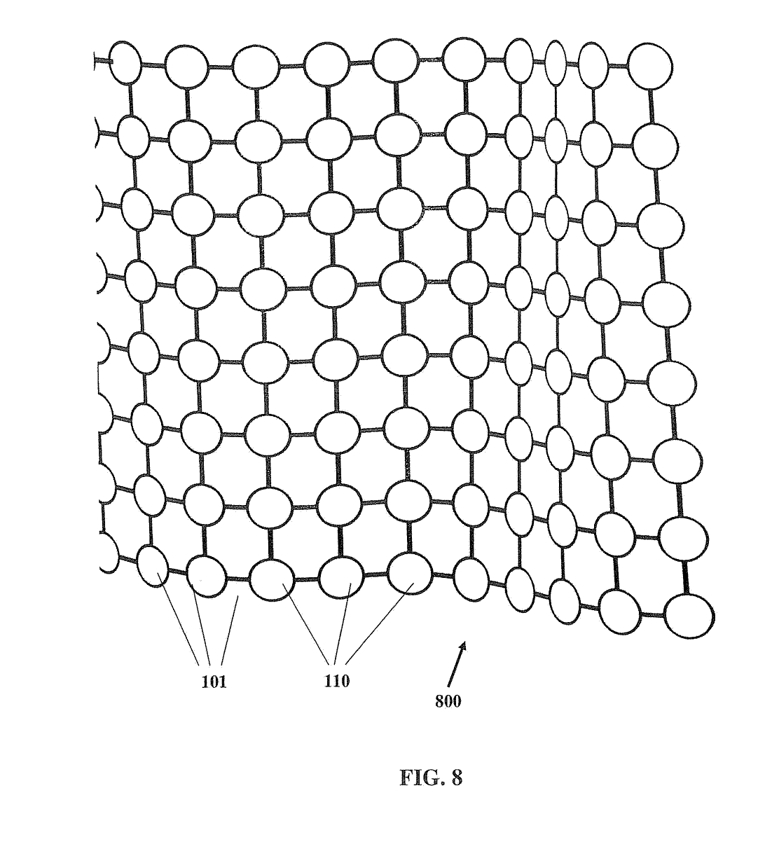

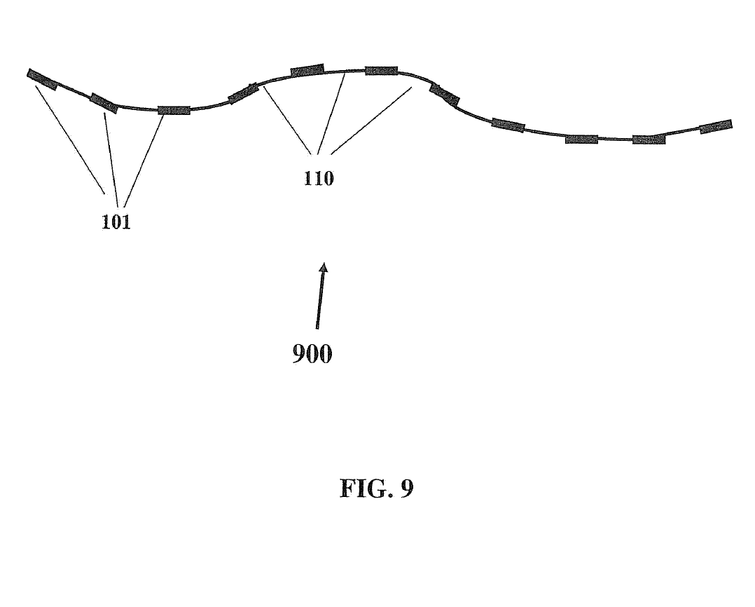

FIGS. 8 and 9 show front 800 and top 900 views, respectively, of an example of a non-flat plane (e.g., a curved screen) that may be formed using light sources 101 and connecting elements 110. As shown in this example, the screen may be formed in three dimensions in a non flat grid. Such a grid may be implemented using interconnecting elements 110 along one connection axis (either power or data) that can be non-linear, bent, or curved. Using interconnecting elements 110 that can be non-linear, bent, or curved along both axes (e.g., power and data) may be used to implement a screen having a spherical or other more complex shape.

The pixel emitter assemblies with polarized states may be used to present a viewer with the effect of watching 3D or stereoscopic images or video as explained below. The 3D effect requires that the viewer's binocular vision can be activated by presentation of two separate images (produced from two recording devices spaced to approximate normal eye separation) to each eye simultaneously. The data flow provided to the pixel emitter assemblies include the two sets of images. The pixel emitter assemblies separate the two sets of images into the correct respective stereo images for presentation to a viewer as explained in further detail below.

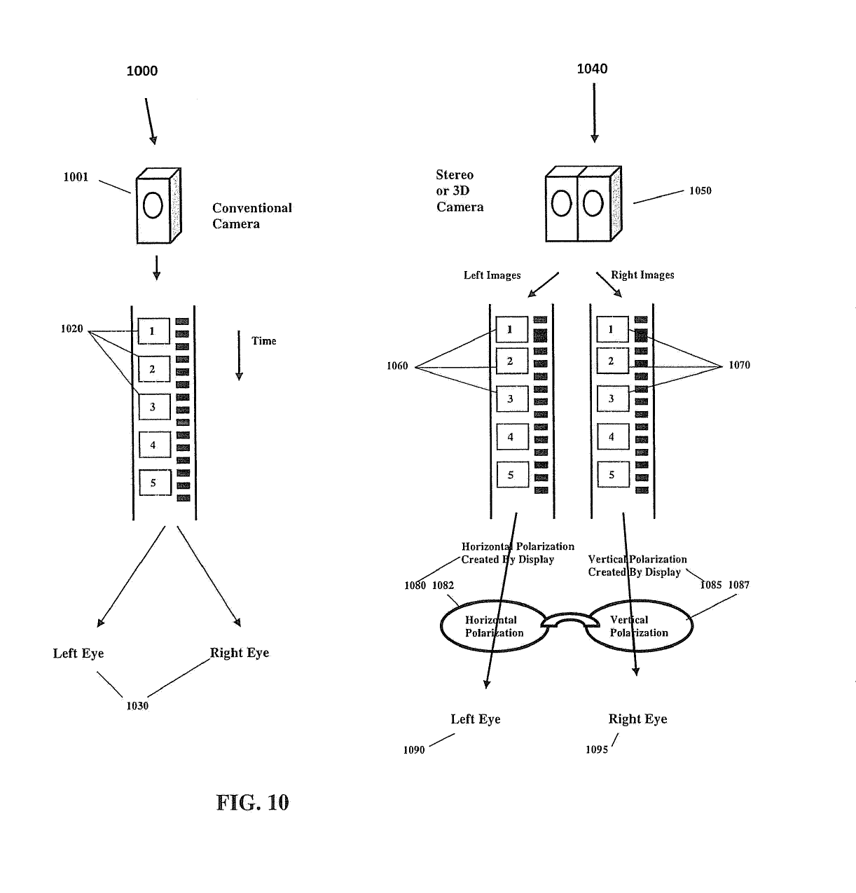

FIG. 10 shows an example 1000 of a conventional camera 1001. The camera 1001 may be video, film, or any other form of recording media that records a moving picture as a series of still photos 1020. By providing the sequence of still photos 1020 at rate faster than the persistence of human vision, (e.g., approximately 20 milliseconds), the human viewer sees a continuous moving picture. In this example, both the left and right eyes 1030 can be presented with the same image set 1020. The result can be an image that appears as flat, or 2 dimensional, to the viewer.

In order to provide a stereoscope or 3D image, both eyes can be presented with separate images to account for binocular vision (providing a depth perspective/perception), e.g., as shown in example 1040. A 3D camera 1050 may be used for this purpose. The 3D camera 1050 has two sets of lenses and image recorders. The lenses can be separated by a distance approximately equal to the average separation of the human eyes. Of course, if scale models or imagery can be to be photographed in 3D, the camera lens separation also can be scaled accordingly. The two sets of lenses record two sets of images 1060 and 1070 each represent the view that would be seen by the left eye or the right eye. The sets of images can be then separated into the left and right eye images for viewing. The pixel emitter assemblies accomplish the separation of images by presenting the left images using a first polarization (e.g., horizontal polarization) 1080 and the right eye images using a second polarization orthogonal to the first (erg., vertical polarization) 1085. When a viewer of the images can be wearing a pair of eyeglasses or lenses wherein the left eye has a lens formed of a polarization material oriented horizontally 1082 and the right eye having a lens of polarization material oriented vertically 1087, the left eye of the viewer sees only the left image 1060, and the right eye sees only the right image 1070. The result can be a 3D vision effect to the viewer.

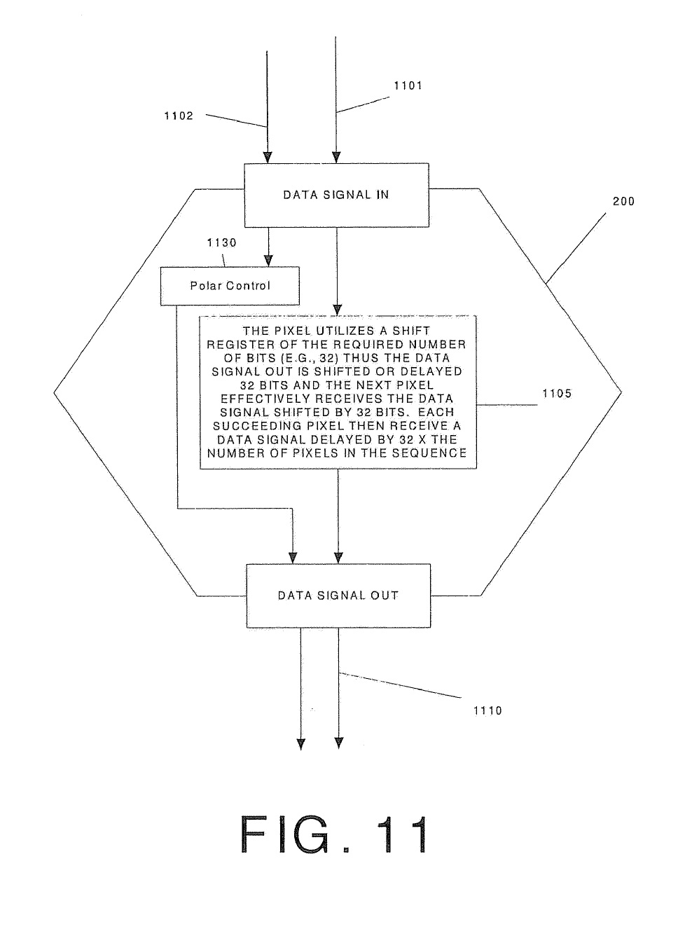

FIG. 11 illustrates one example 1100 of data flow within a pixel emitter assembly 200. The data flow includes a serial image data stream 1101 and a polarization signal stream 1102. The data flow can be received by a pixel emitter assembly 200 from a strut 400 via one of its data contacts 210. The image data stream 1101 can be a serial stream of data bits that represent intensity values for the LEDs of the pixel emitter assembly 200. The pixel emitter assembly 200 processes 1105 the received data stream 1101 to extract a data package (e.g., a predetermined number of bits) from the serial bit stream corresponding to a desired intensity and/or color to be output by its LEDs. In one example, each pixel emitter assembly 200 includes a memory device (e.g., a shift register) for storing the same number of bits as the desired data package (e.g., 32 bits). The serial data stream 1110 can be shifted into and/or out of the pixel emitter assembly 200 according to a clock pulse. When the data intended for the particular pixel emitter assembly 200 can be shifted into the register, a single latch pulse triggers the data in stored in the shift register for use by the pixel emitter assembly 200 as the intensity/color display data for the pixel emitter assembly. The data flow within a screen can be described in further detail below.

The polarization signal 1102 can be provided to polarization control electronics 1150 of the emitter board 201. For the polarization of the pixel emissions to provide a 3D effect, two sets of data representing the left eye image and the right eye image can be required. This double set of data can be streamlined into a single data stream 1101 and extracted as two images by use of the polarizing signal 1102.

For 3D, the two image sets can be provided as video signals interlaced with each other, representing the left view and the right view of a stereo or 3D pair. The polarizing signal 1102 indicates whether the signal at a particular instant can be a left view, right view, or neither. The polarizing signal includes two square waves to synchronize the polarization of each pixel. In one configuration, the polarization signal 1102 can be passed through the same struts as the display data stream, but the power struts also may be used. In one example, the entire screen uses the same polarization signal simultaneously (e.g., the entire screens shows the left view and then the right view) at a very fast switching rate, however, this may be done simply for convenience of explanation herein, and other switching schemes and interlacing of left and right views may be used.

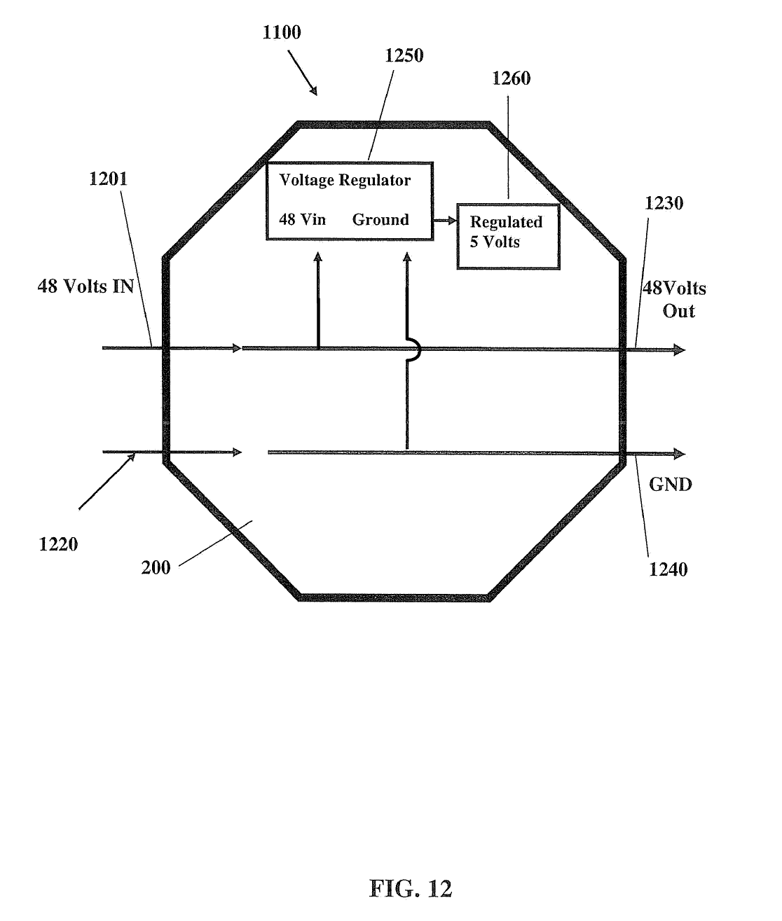

FIG. 12 illustrates one example 1200 of power flow within a pixel emitter assembly 200. The pixel emitter assembly 200 includes power contacts 215 for receiving at least a voltage source to power the pixel emitter assembly 200. For example, the power contacts 215 may include contacts to receive a positive power source 1201 (e.g., 48 volts power supply) and a ground 1220. Both the power source 1201 and ground 1210 can be output to the power contact 215 opposite the receiving power contact 215 as a voltage source out 1230 and a ground 1240. In one implementation, the power received 1201 and ground can be also connected to a voltage regulator 1250. The voltage regulator 1250 processes the received power to produce a power level 1260 that can be compatible with the components of the LED emitter board 201 (e.g., a clean 5 volts DOC). Addition of a voltage regulator provides a reliable and exact 5 volts for use by the pixel emitter assembly 200 despite the voltage noise or drop on the 48 volt power supply line 1201. In addition, the current passing through the struts 500 connected to pixel emitter assembly 200 can be lower than if the power supply line were provided at a lower voltage used by the circuit board (e.g., 5 volts).

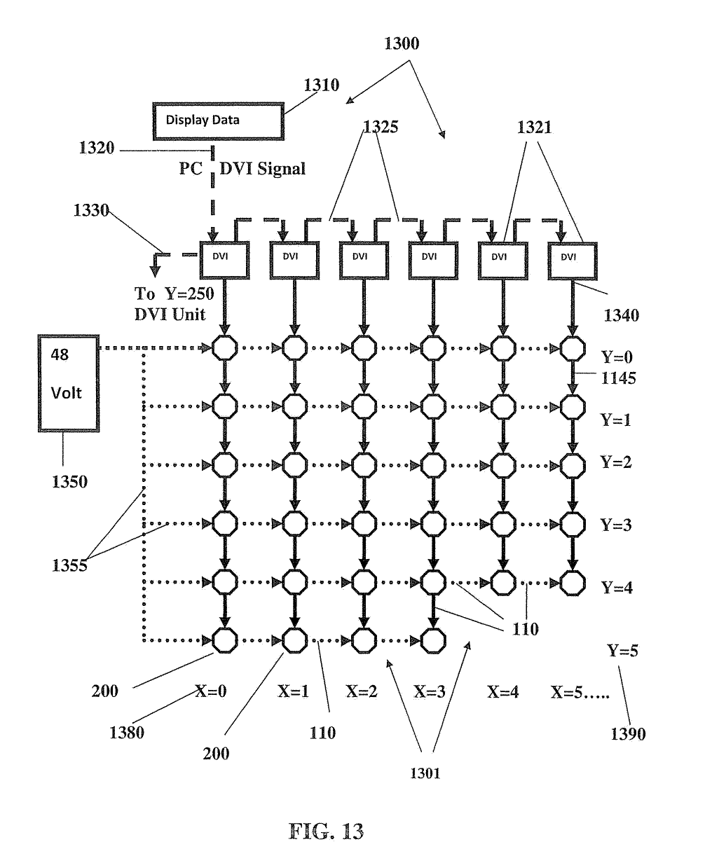

FIG. 13 illustrates an example of data flow for a presentation to be displayed by a screen system 1300. The system 1300 includes a screen 1301 having a number of pixel emitter assemblies 200 assembled in a 6×6 matrix to present display data 1310 to a viewer. The display data 1310 may be may represent a shape, a pattern, an object, a picture, an image, a video, or any other desired lighting desired to be presented to a viewer According to the example shown in FIG. 13, the display data 1310 may include video images. The display data 1310 also may include polarizing signals used to control the pixel emitter assemblies 200 to create the left and right eye images, as explained in further detail below.

In exemplary embodiments, the display data 1310 can be provided as a DVI signal 1320 to a DVI unit 1321 using a DVI cable with DVI connectors (e.g., a standard output of PCs intended for an LCD monitor). The DVI signal 1320 can be provided to additional DVI units 1321 using DVI connections 1325 linking the DVI units 1321. As many DVI units 1321 as needed to supply the columns of the screen matrix may be daisy chained together in this manner. However, additional banks of DVI units 1321 using a second DVI output connection 1330 may be used when implementing larger screens, as explained in further detail below. Each of the DVI units 1321 presents a data stream derived from the DVI signal 1320 to the beginning of an associated column of pixel emitter assemblies 200 via cables 1340, as explained in detail below. The cables 1340 include a connector (e.g., a connector 510) that mates with the slot 225 of each pixel emitter assembly 200 in the first row of the screen matrix. Of course, while embodiments are described herein in the context of DVI signals/hardware, other suitable signal and/or hardware formats/configurations (e.g., HDMI, USB, USB II, etc.) can be used.

Power can be supplied to the screen 1301 by a power supply 1350. The power supply 1350 can be connected to the first column of pixel emitter assemblies 200 via power cables 1355. The power cables 1355 can be provided with connectors (e.g., a connector 510) that can be inserted into the slot 225 of an associated pixel emitter assembly 200 of the first column.

Each DVI unit 1321 can be uniquely designated according to its position in the matrix of the screen. For example, as shown in FIG. 13 the X values 1380 designate the column numbers, and the Y values 1390 designate the row numbers. As shown in FIG. 13, the X values or columns start from 0 (the first column) to 5 (the sixth column), and the Y values also start from 0 (the first row) to 5 (the sixth row). Each of the DVI units 1321 can be provided with an identification based on their X and Y value locations within the screen matrix For example, the first DVI unit that receives the display data 1310 directly via the DVI signal 1320 at the beginning of the first column can be designated X=0, Y=0. The DVI unit positioned to its immediate right can be designated as X=1, Y=0; the next one can be designated X=2, Y=0, and so on. In this manner, each DVI unit 1321 may be uniquely identified and knows its location with respect to the screen matrix 1301. The screen matrix 1301 shown in FIG. 13 can be for illustration purposes only. In particular, larger and smaller screens can be possible. For example, for a screen of 192 rows and 256 columns includes X values from 0 to 255 and Y values from 0 to 191, respectively.

The DVI display data can be provided to each DVI unit 1321 through the data chain sequence 1310, 1320, and 1325. Each DVI unit 1321 extracts a data set from the overall data signal 1320 for the pixel emitter assemblies 200 of the column to which the DVI unit 1321 can be connected based on its location in the screen matrix. A column of pixel emitter assemblies 200 receives its display data from the DVI unit 1321 connected to the beginning of the column. Therefore, DVI unit 0,0, ( e.g., DVI unit at X=0, Y=0) extracts the video data for the pixel emitter assemblies X=0, Y=0; X=0, Y=1; X=0, Y=2, X=0, Y=3; X=0, Y=4; and X=0, Y=5.

The DVI unit 0,0 extracts a subset of the image data 1310 representing a portion or number of pixels of the overall video image that can be to be displayed by the pixel emitter for its associated column. For example, the DVI unit 0,0 extracts a subset of the data and processes the data to output a serial data sequence that can be provided to the data contact of the first pixel emitter assembly of its associated column. In this example, a serial data sequence provides the data in a serial bit stream with a first data set or predetermined number of bits in the serial data stream intended for the Y=5 pixel emitter assembly first followed by a second data set or predetermined number of bits for the next pixel emitter assembly at Y=4, followed by yet another data set or predetermined number of bits for the next pixel emitter assembly at Y=3, and so on. In other words, the DVI unit arranges the data and outputs a serial data stream with the data set intended for the last pixel emitter assembly in the column provided first in the data stream sequence. The data stream sequence for the extracted subset of the display data can be generated by the DVI unit and sent via link 1330 to the first pixel emitter assembly in the column.

The data stream sequence can be provided to the first pixel emitter assembly in the column. As described above, each pixel emitter assembly can be programmed to receive and/or shift each data set a predetermined number of bits (e.g., 32 bits). The data that corresponds to the desired intensity values for the LEDs can be shifted 32 bits for each pixel emitter assembly the data passes through. The second pixel in the chain receives the second data set in the original data stream sequence output from the DVI unit. The second pixel emitter assembly forwards or shifts the remainder of the data sequence stream to the next pixel emitter assembly in the column 0,2 and so on. After the complete data sequence has been transmitted within the column, each pixel emitter assembly stores its own unique 32 bit data set that makes up the data stream sequence. As a result, the entire data stream sequence has been clocked into the series of shift registers of the pixel emitter assemblies that make up the column of pixels of the screen. The unique set of 32 bits of each data set stored in each pixel emitter assembly 200 at the end of the transmission sequence corresponds to the desired intensity and color control for that pixel.

As described above, the entire data stream sequence can be clocked into the string of shift registers, each consisting of a pixel emitter assembly 200 of 32 bits. When the entire data stream sequence has been shifted into the string of pixel emitter assemblies, a single latch pulse (which propagates through all the pixel emitter assemblies) triggers the individual pixels to utilize the data set stored within their shift registers as the intensity/color data for its pixel. Each pixel emitter assembly 200 passes the data stream sequence to the next pixel emitter assembly via the strut interconnection 1345. In this manner, each pixel emitter assembly can be fed the correct display data for its pixel associated with the overall image of the image data 1310.

For the polarization of the pixel emissions to provide a 3D effect, two sets of data, representing the left eye image and the right eye image can be required. This double set of data can be streamlined into a single data stream, then extracted as two images by use of the polarizing signal. To provide a 3D effect, each DVI unit 1321 passes two sets of video signals interlaced with each other, representing the left view and the right view of a stereo or 3D pair. The Video source 150 indicates whether the signal being sent at any instant can be a left view, right view, or neither. The polarization signal includes two square waves to synchronize the polarization of each pixel. In one configuration, the polarization signals can be passed through the same struts as the DVI display data stream, but the power struts also may be used. For simplicity, embodiments shown and described herein are described in the context of the entire screen using/employing the same polarization signal simultaneously (e.g., the entire screens shows the left view then the right view at a very fast switching rate); however, other polarization signal schemes may be used.

An exemplary power distribution scheme is also shown in FIG. 13. As depicted, each pixel emitter assembly can be powered by 48 volts DC. The 48 volt DC power can be processed by a voltage regulator of the pixel emitter assembly to produce 5 volts DC for use by the electronics of the assembly. The 48 Volt power supply 1350 can be branched to the first pixel emitter assembly of each row via cables 1355. This presents the 48 volts to all pixel emitter assembly with column designation X=0. Thereafter, each pixel emitter assembly passes the 48 volt power to the adjacent pixel emitter assembly via the struts 401 running along the Y axis of the screen matrix 1301

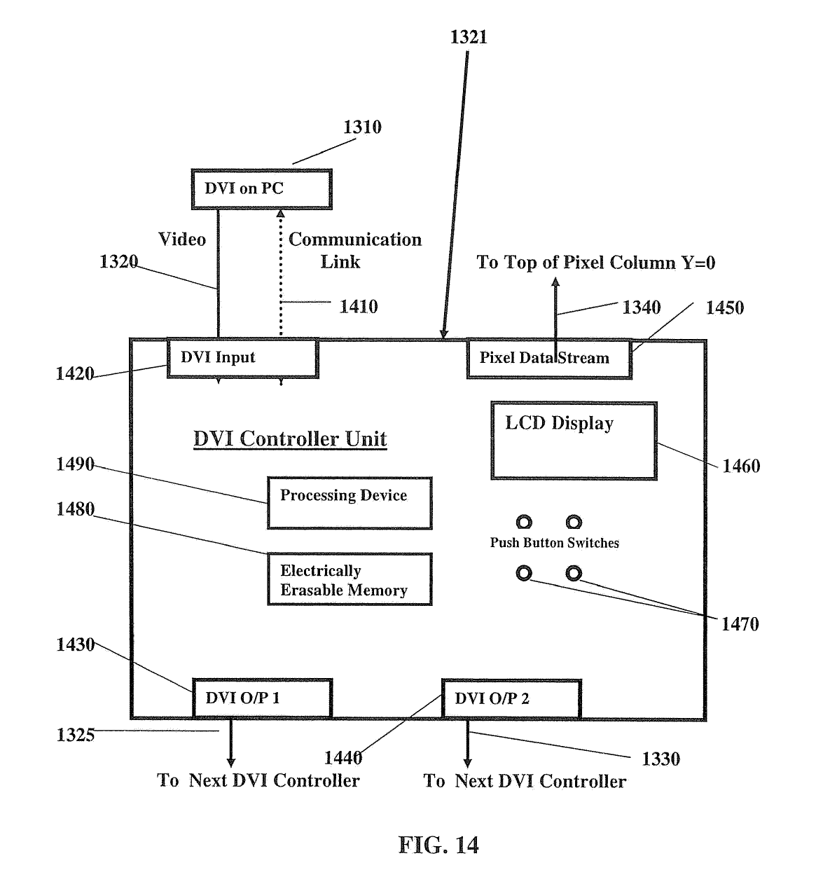

FIG. 14 shows a block diagram of an exemplary DVI unit 1421. Each DVI unit 1421 may include one DVI type connector input 1420, two DVI type outputs 1430 and 1440, a pixel data stream output 1450, a display 1460, an input device 1470, and a memory device 1480, and a processor or logic 1490.

The DVI input 1420 receives a DVI signal from the DVI signal 1320 from the prime video signal provider 1310, or from a DVI output 1430 or 1440 of a preceding DVI unit. The DVI type outputs 1430 and 1440 provide DVI connections for additional connection with additional DVI units, for example, via links used for the connections 1325 and 1330. The a portion of the received DVI signal can be formatted as the data stream sequence 1450 and can be output to connection 1340 which provides the data stream sequence to the first pixel emitter assembly 200 of the associated column connected to that particular DVI unit.

Since each DVI unit can be at the beginning of a different (e.g., uniquely located in the overall screen) column of pixels, each DVI unit provides a unique data stream sequence for its associated column. In order to identify and extract the data stream sequence from the overall screen DVI signal 1320, the location of the column and the column length can be provided to the DVI unit 1321. In one example, each DVI unit 1321 can be programmed with an identification for its column and the column length, both of which can be reference herein as the DVI ID. The DVI ID may be entered for each DVI unit using the input 1470 (e.g., pushbutton switches or dials). The display 1460 (e.g., an LCD) may be configured to display the DVI ID entered by the input 1470. The DVI ID data may be stored in a memory device 1480 (e.g., a non-volatile memory) so that the DVI ID need only be entered once. In this manner, each DVI unit 1321 can be able to identify its position in the overall screen, and which data to extract for use by its assigned column of pixel emitter assemblies.

The processor device or logic 1490 processes the DVI signal received on input 1420 to generate the data stream sequence. The processing device 1490 extracts a subset of the overall data signal 1320 associated with its portion (ergo, column) of the overall display based on the ID stored in the memory device 1360. For example, if a DVI unit 1320 can be assigned the location X=N and Y=M, and can be assigned to control a string of 250 pixels, then the DVI unit 1320 extracts from a video image signal (ergo, typically 480×640 or more), the color and intensity data for pixels X=N, Y=M; X=N, Y=M+1; X=N, Y=M+2; X=N, Y=M+3; X=N, Y=M+5; . . . and so on up to pixel X=N, Y=M+249. The color/intensity data for the 250 pixels can be then arranged into a combined data stream sequence (ergs, 32×250 or 8000 bits). The data stream sequence can be transmitted serially with data for X=N, Y=M+249 first and X=N, Y=M last, as described above. When the combined data stream sequence can be transmitted to the 250 shift registers that can be serially connected in a chain of 250 pixel emitter assemblies 200, the 32 bit long intensity and color data set for each pixel can be stored in the correct pixel when the 8000^{th} bit can be clocked in. In other words, the 32 bit shift register in each pixel emitter assembly 200 can be effectively daisy chained to the next pixel emitter assembly 200, so that 250 pixels daisy chained together forms a combined 32 bit×250=8000 bit shift register that stores the data stream sequence.

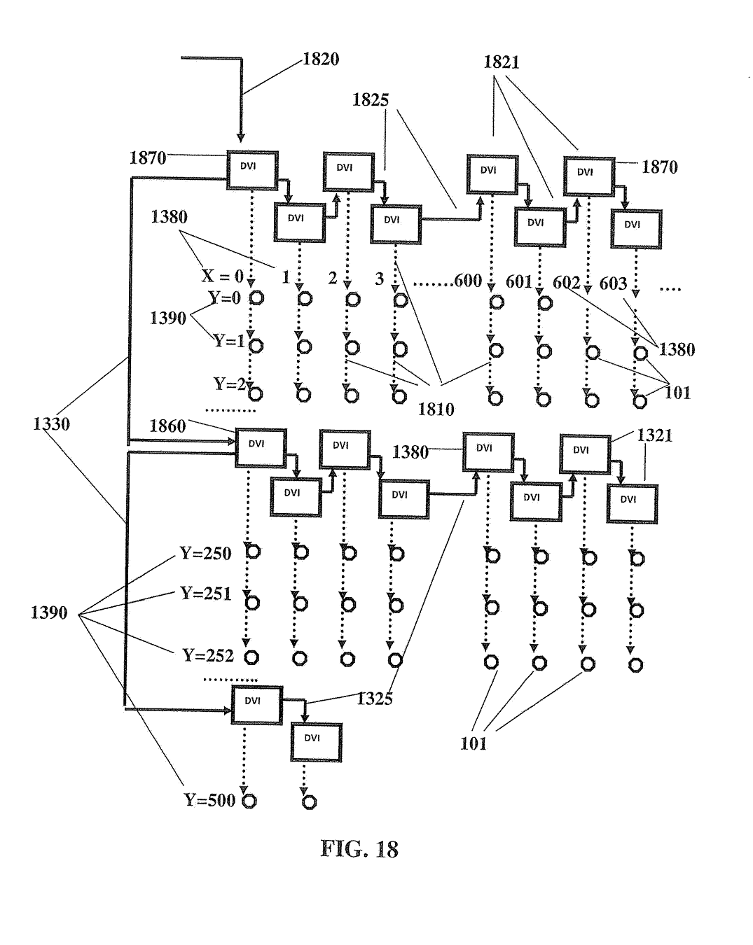

Each DVI unit 1321 may provide data for a column of up to a predetermined number of pixel emitter assemblies (e.g., 250 pixel emitter assemblies). For larger screens above the predetermined number (e.g., above 250 pixel emitter assemblies) in height, additional DVI units may be installed to, e.g., as shown in FIG. 18.

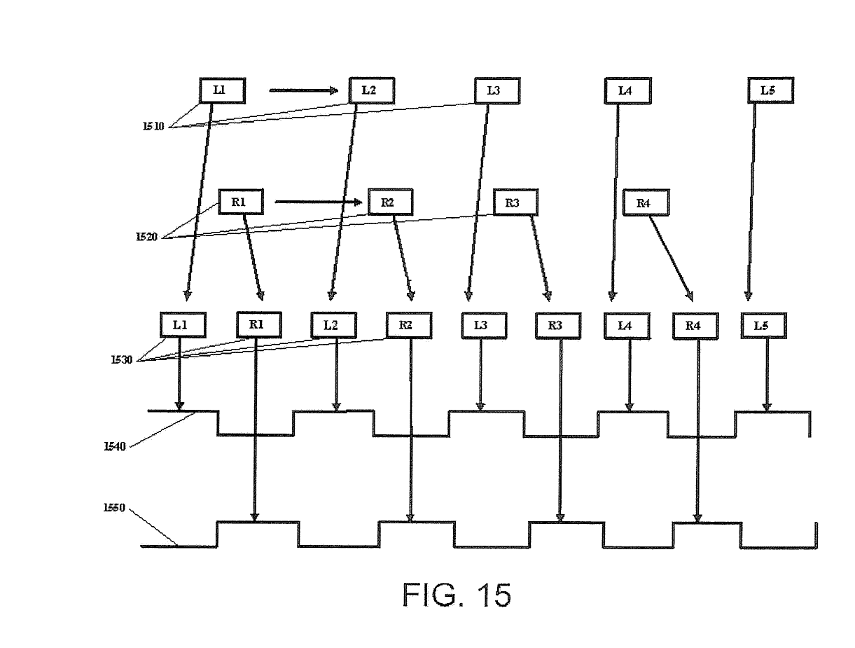

FIG. 15 shows the sequence of still picture frames for a 3D effect including the left eye image sequence 1510 and the right eye image sequence 1520. The sequence of images 1510 for presentation to the left eye over time can be L₁, L₂, L₃, L₄, L₅, . . . , L_{N}. Similarly, the still images to be presented to the right eye can be R₁, R₂, R₃, R₄, . . . , RN. For simplicity, the L and R images represent full screen, still images. The video source 150 interlaces the two sets of L and R still images into a serial stream of images 1530 that including L₁, R₁, L₂, R₂, L₃, R₃, L₄, R₄, . . . , L_{N}, and R_{N}. The video source sends this sequence 1530 for the display data 1310 which can be supplied to the appropriate DVI units 1321. The display data 1310 also contains the polarization control signals. The polarization control signals can be enable/disable signals 1540 and 1550 synchronized to the left image/right image sequence 1530. The horizontal polarization enable signal 1540 can be high when a left image can be sent to 1321 and low when the right image can be sent to 1321. Similarly, the vertical polarization enable signal 1550 can be high when a right image can be sent to 1321 and low when a left image can be sent to 1321.

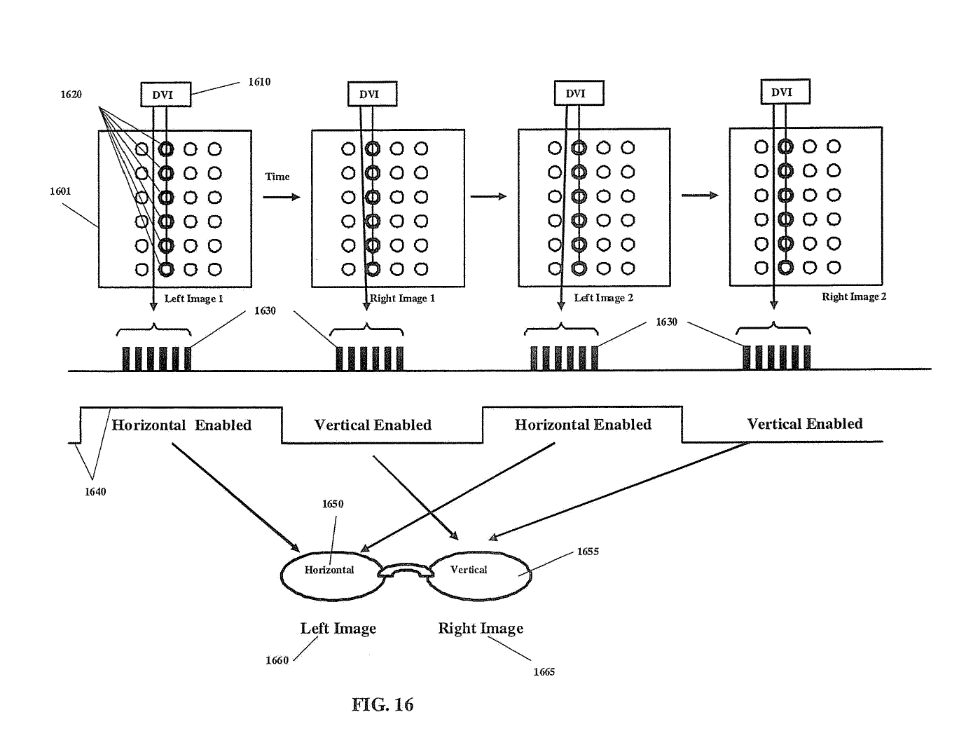

FIG. 16 shows one example 1600 a portion of a screen 1601 and a DVI unit 1610 through a sequence of time for the polarization of images. The DVI unit 1610 controls a column set of polarization pixel emitter assemblies 1620. The data 1630 representing a portion of the overall image emitted by the column 1620 changes with each still frame presented by the screen. The horizontal enable 1540 and vertical enable 1550 signals enable the horizontal and vertical polarization of the pixels according to the sequence 1640. In other words, when a sequence of data for a left eye image can be provided to each of the pixel emitter assemblies 1620 a control pulse for horizontal polarization also can be provided to each of the pixel emitter assemblies 1620 which emit horizontal polarized light from their LEDs 205 according to the image data provided to each pixel emitter assembly. When a sequence of data for a right eye image can be provided to each of the pixel emitter assemblies 1620 a control pulse for vertical polarization also can be provided to each of the pixel emitter assemblies 1620 which emit vertical polarized light from their LEDs 205 according to the image data provided to each pixel emitter assembly. Therefore, left eye images can be horizontally polarized and right eye images can be vertically polarized. When a viewer can be wearing eyeglasses fitted with polarized lenses where the left lens 1650 can be horizontally oriented for the left eye and the right lens 1655 can be vertically oriented for the right eye, the viewer's left eye sees only the intended left image 1660 and the viewer's right eye sees only the right image 1665. The resulting effect can be a reconstructed 3D or stereoscopic image as perceived by the viewer.

As shown in FIG. 17 a viewer may be provided with cross polarized viewing device 1700. In one example, the viewing device 1700 can be glasses 1701. When the glasses 1701 can be worn, the viewer perceives the images as occupying three dimensions or having a 3D quality or effect. The glasses 1701 include two lenses 1710 and 1712 that can be cross polarized to each other. Each lens can be formed using a commercially available polarizing material. The polarization material of the left lens 1710 can be oriented to block light of the first polarization angle. The polarization material of the right lens 1712 can be oriented to block light of the second polarization angle. When polarized light can be emitted by a pixel emitter assembly 200, the image seen by the left eye can be isolated to the left eye by the polarization of the left eye lens 1710 (since it can be cross polarized relative to the right lens 1712), and the image seen by the right eye can be isolated to the right eye lens 1712 (since it can be cross polarized relative to the left lens 1710). Other viewing devices 1700 may be used including goggles, masks, and any other viewing device that isolates polarized light emitted by the pixel emitter assembly to a left eye image and right eye image based on the polarizing angle of light emitted by the pixel emitter assemblies.

In the example shown in FIG. 18, additional DVI units can be installed to drive the data stream sequence for columns that have more than the predetermined number of pixel emitter assemblies. In this example, each DVI unit may process data for a column of up to 250 pixel emitter assemblies. Therefore, for a column of 500 pixels an additional row 1860 of DVI units 1321 can be employed A first DVI unit 1860 of the second row (e.g., X=0, Y=250) receives a DVI data signal from the first DVI unit (e.g., X=0, Y=0) of the first row 1870 from the DVI output 1340 and DVI connection 1330. The DVI signal received by DVI unit 0,250 can be then provided to the additional DVI units of row 1860 using the DVI outputs 1330 to branch the DVI video signal to the second row 1860 of DVI units 1321. Similarly, when the screen column length exceeds 500 pixel emitter assembly, a third row of DVI units 1321 may be provided, as shown in FIG. 13 starting at row Y=500. Of course, if the screen height were not an exact multiple of 250, for example 600 pixel emitter assemblies in a column, then three rows of DVI units 1321 may be assigned 200 pixel emitter assemblies each to equalize the processing load. In one example, the number of pixel emitter assemblies 200 a single DVI unit 1321 may control can be balanced by the desire to provide a short screen refresh time (e.g., such that flicker can be minimized and/or not perceptible to the human eye). Of course, the longer the total data stream sequence, the longer the time between each screen refresh, as the entire data stream sequence can be serially clocked into the string of pixel emitter assemblies.

Each pixel emitter assembly 200 in a video array of a screen has a specific intensity and color for any particular refresh of the overall displayed video image. In addition, the light emitted by each pixel emitter assembly 200 may be in any of four possible polarization states, as determined by the polarization control signal data. The four possible states are: polarization state 1, polarization state 2, no polarization, and no image.

The light emitted during the first and second polarization states can be orthogonal (e.g., 90 degrees to each other) or cross polarized to each other. As described above, the two polarized states can be achieved by activating a specific area of the polarization control assembly 217 to block light from the undesired polarization direction leaving only the desired polarization area to emit light. The third state can be obtained by the non-activation of either polarization control directions to allow light to pass through both areas of the polarization control assembly 217 resulting in non polarized light.

A video screen formed of the polarized modular pixels with polarization states, displays video images with a controllable and variable polarization angle. The video images supplied to the pixel emitter assemblies may be separated into left eye images and right eye images to recreate binocular vision. In addition, the left eye and right eye images may be synchronized to different polarization angles, for example, corresponding to the polarization states that can be cross-polarized or orthogonal. As a result, the presentation of a left eye image of one polarization direction (e.g., the first state) and the presentation of the right eye image with the cross polarization angle relative to the left eye image can be provided (e.g, the second state). When a viewer wears a viewing device, the image can be perceived by the view as having three dimensional qualities or a 3D effect. Both of the polarized images may be seen by a viewer from any visible angle of the screen. In addition, both of the polarized images can be emitted from the same pixel modules at different times. As a result, the left eye image and the right image appear to any viewer in exactly the same place, although they represent different viewpoints. Furthermore, no subdivision of the image or screen can be necessary to produce the cross polarized images. Therefore, the image has at least twice the definition of any convention methods using divided sub areas to provide the different polarized images.

The video screen may be used as a lighting source and as a video display. By using different control data and sources the system may be used as a full time video display, or as a full time lighting source, or the system may be used as both a video display and a lighting source at different times. Because the screen can be designed to be nearly transparent, anything positioned behind the screen relative to a viewer can be visible to the viewer. Also, should the viewer be behind the screen, his view through the screen to the exterior vista can be unhindered. The transparency allows great flexibility in architectural designs where a video screen may be both visible and invisible simultaneously, as illustrated by previously mentioned examples. When used as lighting, the screen provides a wide angle or soft light source while not obstructing the surrounding area to viewer.

When implemented as a free standing screen, air may pass freely through the structure allowing heat, air conditioning, or sound direct access through the screen. In addition, because the structure can be light in weight and allows air to pass through, the structure also has a very small wind profile (e.g., can be not susceptible to being blown by the wind).

The light source 101, such as a pixel emitter assembly, can be a modular unit. As a result, a screen having a number of pixel emitter assemblies may be configured in a number of rows and columns to construct a screen of any desired size. Due to the modular nature of each pixel emitter assembly, the screen may be constructed in an irregular shape, (e.g, non rectangular). For example, if the space where the screen to be deployed has irregular in shape, such as a cut out for a portal, the screen may be configured or adapted to each individual application allowing the maximum number of pixel for the area and provide the fullest coverage. In one example, the screen may be used on stage as part of the props or setting and a portal for actors may be provided. In this configuration, modular pixels where the portal can be positioned may be left out. The modularity and fact that the screen may be broken down into two main components also facilitates system installation.

The modularity of the screen components also makes screen repair and maintenance extremely simple by allowing substitution of a failed pixel emitter assembly or strut without having to maintenance or replace the entire screen. The cost of manufacture can be also reduced because of the few part types (e.g., the light source and interconnecting elements) which can be identical components replicated many times to construct the screen.

A number of exemplary implementations and examples have been described. Nevertheless, it will be understood that various modifications may be made. Suitable results may be achieved if the operations of described techniques can be performed in a different order and/or if components in a described system, architecture, device, or circuit can be combined in a different manner and/or replaced or supplemented by other components. For example, various light sources may be used and orientation of devices may be changed (e.g., row of pixels and columns for power supply). Accordingly, the above described examples and implementations can be illustrative and other implementations not described can be within the scope of the present disclosure. Moreover, the following claims can be by way of example and do not define the scope of the present disclosure.

What is claimed is:

1. A modular pixel emitter assembly to implement a pixel in a screen, the assembly comprising:
an input configured to receive a pixel intensity data and a polarization data, the polarization data indicating one of a first polarization state and a second polarization state;
an emitter circuit board including the input;
at least one light emitting diode (LED) connected to the emitter board and configured to emit light for the pixel according to the pixel intensity data; and
a polarization control assembly configured to polarize the emitted light to a first angle of orientation in response polarization data indicating the first polarization state and to polarize the emitted light to a second angle of orientation orthogonal to the first angle in response polarization data indicating the second polarizing state.

2. The assembly of claim 1, wherein the polarization control assembly includes a first polarizing layer, second polarizing layer, and a liquid crystal display (LCD) layer.

3. The assembly of claim 1, wherein the polarization control assembly includes a first area and a second area, the first area configured to be transparent in response to polarization data indicating the first polarization state and to be opaque in response to polarization data indicating the second polarization state, and the second area configured to be transparent in response to polarization data indicating the second polarization state and to be opaque in response to polarization data indicating the first polarization state.

4. The assembly of claim 2, wherein the first polarizing layer includes a first area configured to allow light having the first angle of orientation to pass through the first area and a second area to allow light having the second angle of orientation to pass through the second area, and the second polarizing layer includes a first area to allow light having the second angle of orientation to pass through the first area and a second area configured to allow light having the first angle of orientation to pass through the second area where the first area of the first layer corresponds to the first area of the second layer and the second area of the first layer corresponds to the second area of the second layer.

5. The assembly of claim 4, wherein the LCD layer includes a first area corresponding to the first areas of the first and second layers and a second area corresponding to the second areas of the first and second layers where the first and second areas of LCD layer rotate light entering the LCD layer 90 degrees.

6. The assembly of claim 5, wherein a control voltage applied to the first area of the LCD layer inhibits light from passing through an area polarization control assembly corresponding to the first areas and a control voltage applied to the second area of the LCD layer inhibits light from passing through an area polarization control assembly corresponding to the second areas.

7. The assembly of claim 1, further comprising a processing device connected to the emitter circuit board to process the intensity data and polarization data to control the at least one LED to output the desired intensity and to control the polarization control assembly to polarize the emitted light.

8. The assembly of claim 1, wherein the first angle polarizes light corresponding to a left eye image and the second angle of polarizes light orthogonal to the first angle corresponding to a right eye image.

9. The assembly of claim 1, wherein the control assembly can be placed in the first polarization state when the pixel intensity data corresponds to a left eye image and the control assembly can be placed in the second polarization state when the pixel intensity data corresponds to a right eye image.

10. The assembly of claim 1, wherein when the control assembly can be placed in a third polarization state the emitted light can be not polarized.

11. The assembly of claim 1, further comprising a cover to diffuse the polarized light from the control assembly evenly over a desired angle of emission.

12. The assembly of claim 1, wherein the LED can be a tri-color LED to emit colored light corresponding to the desired intensity.

13. The assembly of claim 1, further comprising a plurality of LEDs connected to the emitter circuit board to emit light according to a desired intensity for the pixel.

14. A modular video screen including a matrix of pixels to present polarized images, the screen comprising:
a plurality of modular light sources forming the matrix, each modular light source comprising,
an input configured to receive a pixel intensity data corresponding to a pixel in the matrix and a polarization data, the polarization data indicating one of a first polarization state and a second polarization state;
an emitter circuit board including the input;
at least one light emitting diode (LED) connected to the emitter board and configured to emit light for the pixel according to the pixel intensity data; and
a polarization control assembly configured to polarize the emitted light to a first angle of orientation in response polarization data indicating the first polarization state and to polarize the emitted light to a second angle of orientation orthogonal to the first angle in response polarization data indicating the second polarizing state.

15. The screen of claim 14, wherein the polarization control assembly includes a first polarizing layer, second polarizing layer, and a liquid crystal display (LCD) layer.

16. The screen of claim 14, wherein the polarization control assembly includes a first area and a second area, the first area configured to be transparent in response to polarization data indicating the first polarization state and to be opaque in response to polarization data indicating the second polarization state, and the second area configured to be transparent in response to polarization data indicating the second polarization state and to be opaque in response to polarization data indicating the first polarization state.

17. The screen of claim 15, wherein the first polarizing layer includes a first area to allow light having the first angle of orientation to pass through the first area and a second area to allow light having the second angle of orientation to pass through the second area, and the second polarizing layer includes a first area to allow light having the second angle of orientation to pass through the first area and a second area to allow light having the first angle of orientation to pass through the second area where the first area of the first layer corresponds to the first area of the second layer and the second area of the first layer corresponds to the second area of the second layer.

18. The screen of claim 17, wherein the LCD layer includes a first area corresponding to the first areas of the first and second layers and a second area corresponding to the second areas of the first and second layers where the first and second areas of LCD layer rotate light entering the LCD layer 90 degrees.

19. The screen of claim 18, wherein a control voltage applied to the first area of the LCD layer inhibits light from passing through an area polarization control assembly corresponding to the first areas and a control voltage applied to the second area of the LCD layer inhibits light from passing through an area polarization control assembly corresponding to the second areas.

20. The screen of claim 14, wherein each modular light source further comprises a processing device connected to the emitter circuit board to process the intensity data and polarization data to control the at least one LED to output the desired intensity and to control the polarization control assembly to polarize the emitted light.

21. The screen of claim 14, wherein the first angle polarizes light corresponding to a left eye image and the second angle of polarizes light orthogonal to the first angle corresponding to a right eye image.

22. The screen of claim 14, wherein the control assembly can be placed in the first polarization state when the pixel intensity data corresponds to a left eye image and the control assembly can be placed in the second polarization state when the pixel intensity data corresponds to a right eye image.

23. The screen of claim 14, wherein when the control assembly can be placed in a third polarization state the emitted light can be not polarized.

24. The screen of claim 14, wherein each modular light source further comprises a cover to diffuse the polarized light from the control assembly evenly over a desired angle of emission.

25. The screen of claim 14, wherein the LED can be a tri-color LED to emit colored light corresponding to the desired intensity.

26. The screen of claim 14, wherein each modular light source further comprises a plurality of LEDs connected to the emitter circuit board to emit light according to a desired intensity for the pixel.

27. The screen of claim 14, wherein the intensity data supplied to the pixel emitter assemblies includes left eye image data and right eye image data, and the left eye data can be synchronized to the first angle, and the right eye image data can be synchronized to the second angle.

28. The screen of claim 27, wherein the images presented by the screen have a three dimensional quality when viewed by a viewing device having a first lens polarized to the first angle and a second lens polarized to the second angle.

29. A method of controlling a plurality of light emitting elements for creating a 3D effect, the method comprising:
presenting the plurality of light emitting elements as a 2D array for viewing;
with an electronic controller, controlling the light intensity of light output from each of the plurality of light emitting elements;
with a polarization control assembly, selectively controlling the polarization of the light output of each of the plurality of light emitting elements into one of two (three in dependent claim) different polarization states; wherein for each polarization state a separate image can be presented on the 2D array.

30. The method of claim 29, further comprising providing to a viewer a pair of viewing glasses configured and arranged to provide light having one of the two polarization states to the left eye of the viewer and light having the second of the two polarization states to the right eye of the viewer.

31. The method of claim 29, wherein the first polarization state corresponds to light having a first polarization and the second polarization state corresponds to light having a substantially orthogonal polarization.

32. The method of claim 29, further comprising with the polarization control assembly, selectively controlling the polarization of the light output of each of the plurality of light emitting elements into one of thee different polarization states, wherein the third polarization state corresponds to unpolarized light.

33. A computer program product residing on a computer-readable storage medium having a plurality of instructions stored thereon, which when executed by a processing system, cause the processing system to:
produce an intensity control signal for an electronic controller for controlling the light intensity of light output from each of a plurality of light emitting elements, wherein the plurality of light emitting elements are configured and arranged as a 2D array for viewing;
produce a polarization control signal for a polarization control assembly for selectively controlling the polarization of the light output of each of the plurality of light emitting elements into one of two or more different polarization states; and
for each polarization state, present a separate image on the 2D array.

34. The computer program product of claim 33, wherein the two or more different polarization states include three polarization states.

35. The computer program product of claim 34, wherein the three polarization states comprise horizontal polarization, vertical polarization, and unpolarized.

36. The computer program product of claim 34, wherein the intensity control signal is a DVI signal.

37. The computer program product of claim 34, wherein the polarization control signal is a DVI signal.
